(19) United States
(12) Patent Application Publication
(10) Pub. No.: US 2021/0286847 A1
(43) Pub. Date: Sep. 16, 2021

(54) FLEXIBLE MULTI-MEDIA SYSTEM

(71) Applicant: GRANTHIKA COMPLANY, Oakland, CA (US)

(72) Inventors: Vikram Chandra, Oakland, CA (US); Borislav Iordanov, Miami, FL (US)

(21) Appl. No.: 16/317,806

(22) PCT Filed: Jul. 12, 2017
(86) PCT No.: PCT/US17/41692

§ 371 Date: Jan. 14, 2019

Related U.S. Application Data
(60) Provisional application No. 62/361,429, filed on Jul. 12, 2016.

(51) Int. Cl. G06F 16/901; G06F 16/904; G06F 40/146; G06F 40/106; G06Q 30/06

(52) U.S. Cl. CPC G06F 16/9024; G06F 16/904; G06Q 30/0631; G06F 40/106; G06F 40/146

(57) ABSTRACT

A multi-media system may include a computer, and an interface connected to the computer. The system may also include a module executing on the computer that a user enters data into via the interface, the module converts each data entered into a first state and a second state, the first state visible to the user on the interface upon entry by the user, and the second state visible to the user on the interface upon call-up by the user. The system may also include a graph generated on the interface based upon the first state and the second state. The system may additionally include an object linked to the data via the graph.

### BACKGROUND

The embodiments relate to the field of mutlti-media systems.

Certain human propensities remain the same as always: we read texts of all kinds—fiction, non-fiction, poetry, history—and lose ourselves in the worlds they create in our imaginations. The material of these texts has changed; we are no longer looking at ink brushed onto papyrus, or shapes pressed by metal into paper. And yet, we have not re-imagined how text can exist and behave. We keep building digital representations of text that look and act like print on paper.

### SUMMARY

According to one embodiment, a multi-media system may include a computer, and an interface connected to the computer. The system may also include a module executing on the computer that a user enters data into via the interface, the module converts each data entered into a first state and a second state, the first state visible to the user on the interface upon entry by the user, and the second state visible to the user on the interface upon call-up by the user. The system may also include a graph generated on the interface based upon the first state and the second state. The system may additionally include an object linked to the data via the graph.

The system data may include a sequence of TextObjects, and the graph may include edges to which the object is linked, and the object may include meta-data. The graph may include a hypergraph, a directed graph, and/or a multi-graph, and the graph is not a single tree-like structure.

The data may be imported and exported. The data imported may be updated for all users and/or updated as versions. The data imported may be controlled by the user as to version and what data is updated.

The system may also include a search module that enables a user to examine the data on the system, the first state of the data, the second state of the data, the graph, and/or the object. The graph may be Visualized on the interface for the user and the user can observe and manipulate the data in a graphical manner.

The system may further include an output module in communication with the interface that generates a product for the user based upon the data. The data may be Tantra formatted so the user experiences the data on the interface in different configurations.

Another aspect of the embodiments is a method. The method may include entering data into a module executing on a computer and the module converts each data entered into a first state and a second state, the first state visible to a user on an interface upon entry by the user, and the second state visible to the user on the interface upon call-up by the user. The method may also include generating a graph on the interface based upon the first state and the second state. The method may further include linking an object to the data via the graph.

The method may additionally include providing a search module that enables a user to examine at least one of the data on the system, the first state of the data, the second state of the data, the graph, and the object. The method may also include Tantra formatting so the user experiences the data on the interface in different configurations.

The method may further include controlling by the user data imported as to version and what data is updated. The method may additionally include outputting a product for the user based upon the data.

Another embodiment is computer readable program codes coupled to tangible media. The computer readable program codes may be configured to cause the program to enter data into a module executing on a computer and the module converts each data entered into a first state and a second state, the first state visible to a user on an interface upon entry by the user, and the second state visible to the user on the interface upon call-up by the user; generate a graph on the interface based upon the first state and the second state; and link an object to the data via the graph.

The computer readable program codes may also provide a search module that enables a user to examine at least one of the data on the system, the first state of the data, the second state of the data, the graph, and the object. The computer readable program codes may further Tantra format so the user experiences the data on the interface in different configurations.

The computer readable program codes may additionally control by the user data imported as to version and what data is updated. The computer readable program codes may also output a product for the user based upon the data.

### BRIEF DESCRIPTION OF THE DRAWINGS

FIG. 1 is a schematic block diagram of a system in accordance with the embodiments.

FIG. 2 is a schematic block diagram of an alternate embodiment of the system of FIG. 1 in accordance with the embodiments.

FIG. 3 shows a menu of a GUI generated by the relational text system in accordance with the embodiments for FIGS. 1 and 2.

FIG. 4 shows a view of a Characters panel of the menu through which a user has access in accordance with the embodiments for FIGS. 1 and 2.

FIG. 5 shows a view Facts panel in accordance with the embodiments for FIGS. 1 and 2.

FIG. 6 shows a Tags panel in accordance with the embodiments for FIGS. 1 and 2.

FIG. 7 shows the Facts panel for a Group in accordance with the embodiments for FIGS. 1 and 2.

FIG. 8 shows the Facts panel showing the definition of a related location in accordance with the embodiments for FIGS. 1 and 2.

FIG. 9 shows an event creation window presented in the GUI in accordance with the embodiments for FIGS. 1 and 2.

FIG. 10 shows a corresponding Facts panel for FIG. 9.

FIG. 11 shows a timeline or Visualization of Events in accordance with the embodiments for FIGS. 1 and 2.

FIG. 12 shows the “Caused by” option has been selected in accordance with the embodiments for FIGS. 1 and 2.

FIG. 13 shows an example of schema defining in accordance with the embodiments for FIGS. 1 and 2.

FIG. 14 shows linking objects to the schema of FIG. 13.

FIG. 15 shows defining and applying tags in accordance with the embodiments for FIGS. 1 and 2.

FIG. 16 shows embedded markup features in accordance with the embodiments for FIGS. 1 and 2.

FIG. 17 shows an example of the overlapping problem in the prior art.

FIG. 18 shows an improved markup language in accordance with the embodiments for FIGS. 1 and 2.

FIG. 19 shows a relational text system in accordance with the embodiments for FIGS. 1 and 2.

FIG. 20 shows the “Facts” section of the Universe tab in accordance with the embodiments for FIGS. 1 and 2.

FIG. 21 shows the Visualize function in accordance with the embodiments for FIGS. 1 and 2.

FIG. 22 shows a Package in accordance with the embodiments for FIGS. 1 and 2.

FIG. 23 shows example Grantha formats in accordance with the embodiments for FIGS. 1 and 2.

FIG. 24 an amended schema definition in accordance with the embodiments for FIGS. 1 and 2.

FIG. 25 shows an example GUI tool in accordance with the embodiments for FIGS. 1 and 2.

FIG. 26 shows an example GUI tool in accordance with the embodiments for FIGS. 1 and 2.

FIG. 27 shows a shared universe in accordance with the embodiments for FIGS. 1 and 2.

FIG. 28 shows scene sharing in accordance with the embodiments for FIGS. 1 and 2.

FIG. 29 shows variance retention in accordance with the embodiments for FIGS. 1 and 2.

FIG. 30 shows version selection in accordance with the embodiments for FIGS. 1 and 2.

FIG. 31 shows knowledge management layers in accordance with the embodiments for FIGS. 1 and 2.

FIG. 32 is a flowchart illustrating method aspects according to the embodiments.

### DETAILED DESCRIPTION

Embodiments will now be described more fully hereinafter with reference to the accompanying drawings, in which preferred embodiments are shown. Like numbers refer to like elements throughout.

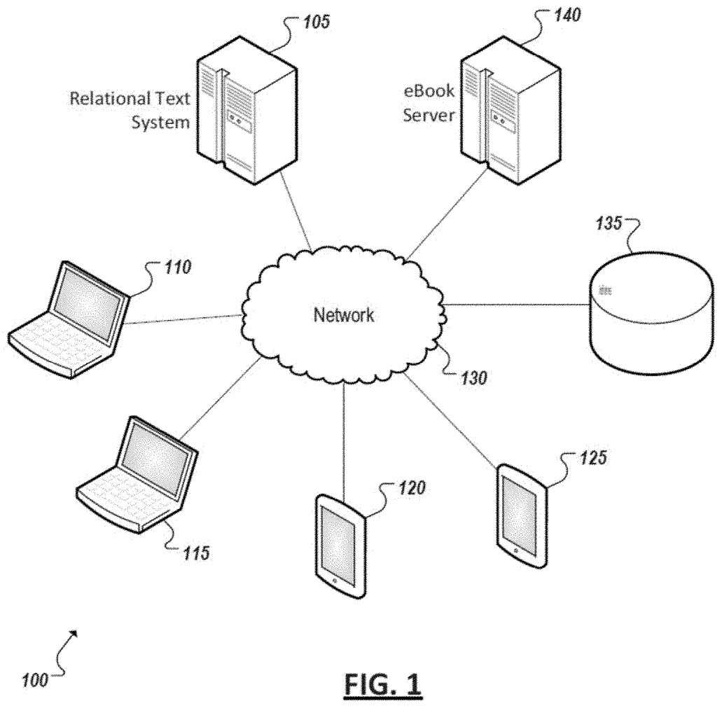

FIG. 1 is a simplified block diagram illustrating an example embodiment of a computing environment 100 including an example relational text system 105. The relational text system 105 can generate text-based document and other files replacing characters with TextObjects, which may be layered with metadata associating combinations of such text objects with structures defined within a narrative work. The text-based document generated using the relational text system 105 can, thus, be embedded with intelligence to assist the author in maintaining consistency throughout the document or even other documents, such as a cannon of prior, related narrative works. One or more user devices (e.g., 110, 115, 120, 125) can interface with the relational text system 105 over one or more networks 130 to generate these documents. In other instances, the relational text system 105 can be hosted locally on one or more of such user devices. Multiple users may be permitted shared access to documents and universes (e.g., maintained by one or more data stores 135) defined using the relational text system 105 such that multiple users, potentially using multiple user devices, can collaborate on the authorship of a single document or a set of related documents (e.g., based on a common universe and/or schema). These documents can serve as the basis of eBooks or other documents, which may be served by one or more services (e.g., 140), which may be likewise accessible to users over one or more networks 130. The electronic documents can be rendered on displays of user devices (e.g., 110, 115, 120, 125) and enable enhanced presentations and features based on the rich, layered data structures upon which the documents are based, as generated by the relational text system 105.

In general, “servers,” “devices,” “computing devices,” “host devices,” “user devices,” “clients,” “servers,” “computers,” “systems,” etc. (e.g., 105, 110, 115, 120, 125, 135, 140, etc.) can include electronic computing devices operable to receive, transmit, process, store, or manage data and information associated with the computing environment 100. As used in this document, the term “computer,” “computing device,” “processor,” or “processing device” is intended to encompass any suitable processing device adapted to perform computing tasks consistent with the execution of computer-readable instructions. Further, any, all, or some of the computing devices may be adapted to execute any operating system, including Linux, UNIX, Windows Server, etc., as well as virtual machines adapted to virtualize execution of a particular operating system, including customized and proprietary operating systems.

Client or user devices (e.g., 110, 115, 120, 125) can further include computing devices implemented as one or more local and/or remote client or end user devices, such as personal computers, laptops, smartphones, tablet computers, personal digital assistants, media clients, web-enabled televisions, telepresence systems, gaming systems, multimedia servers, set top boxes, smart appliances, in-vehicle computing systems, and other devices adapted to receive, view, compose, send, or otherwise interact with, access, manipulate, consume, or otherwise use applications, programs, and services served or provided through servers within or outside the respective device (or environment 100). A host device can include any computing device operable to connect or communicate at least with servers, other host devices, networks, and/or other devices using a wireline or wireless connection. A host device, in some instances, can further include at least one graphical display device and user interfaces, including touchscreen displays, allowing a user to view and interact with graphical user interfaces of applications, tools, services, and other software of provided in environment 100. It will be understood that there may be any number of host devices associated with environment 100, as well as any number of host devices external to environment 100. Further, the term “host device,” “client,” “end user device,” “endpoint device,” and “user” may be used interchangeably as appropriate without departing from the scope of this disclosure. Moreover, while each end user device may be described in terms of being used by one user, this disclosure contemplates that many users may use one computer or that one user may use multiple computers, among other examples.

While FIG. 1 is described as containing or being associated with a plurality of elements, not all elements illustrated within system 100 of FIG. 1 may be utilized in each alternative implementation of the present disclosure. Additionally, one or more of the elements described herein may be located external to system 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

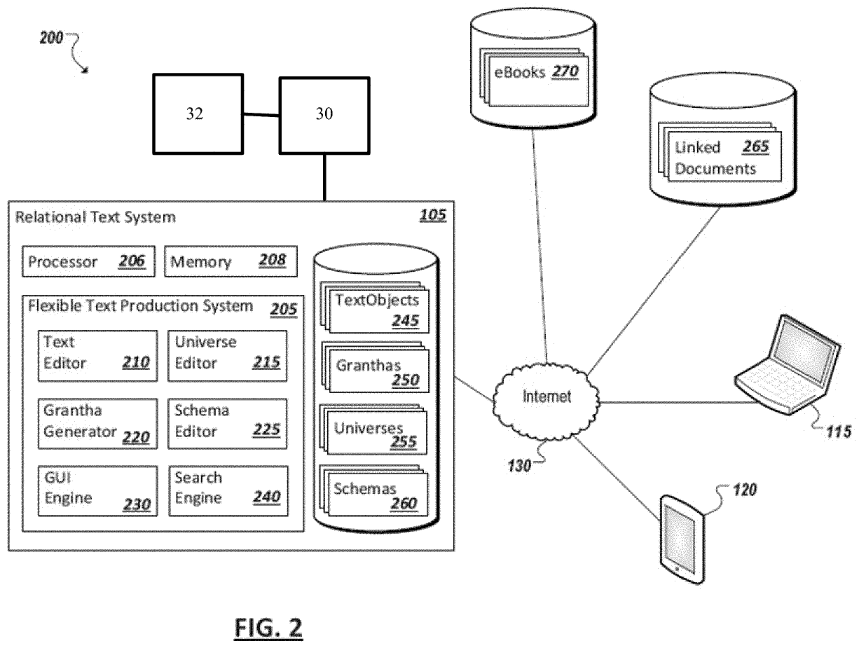

As shown in the example of FIG. 2, a simplified block diagram 200 is shown illustrating a system or computing environment that includes, for instance, an example relational text system 105 that includes a flexible text production system 205 capable of being used to generate sophisticated text-based electronic documents and assist authors in the creation of such documents. In one implementation, the relational text system 105 can include one or more processors and one or more memory elements including instructions, that when executed by the processor(s), implement the functionality of one or more computing modules. In one example, the relational text system 105 may include modules such as a text editor 210 to allow authors to draft text (e.g., in a manner similar to conventional word processors), but further including a universe editor 215 and schema editor 225 (among potentially other modules) through which the user can define structures to be associated with text composed by the user. Rather than generating simple text data (e.g., strings of characters), the text editor 210 may generates TextObjects 245 for each character (e.g., letter, number, space, punctuation mark, etc.) typed, spoken, or otherwise provided by the user (e.g., using a corresponding user device 115, 120). While TextObjects 245 may be generated for every character typed, in some implementations, typed text may only be converted into TextObjects in response to a selection or designation of particular text (e.g., text selected for designation as corresponding to a person, place, things, fact, etc. by a user or system) or other identification that some character sequence is to be identified as an entity and somehow linked to something else. In such implementations, text not determined to correspond to an entity may be stored as conventional text, such as a sequence of bytes.

Structures such as timeline, characters, events, etc. can be defined for a Universe using the universe editor 215 and may, in some cases, be done so, as the author is generating corresponding text. Such structures within the Universe 255 can be associated with graphs of TextObjects generated using the text editor. Further, a schema 260 can be defined, accessed, and/or edited using schema editor 225. Elements of a narrative or document structure can be defined within the schema and can be likewise associated with the TextObject-based graphs. The relational text system 105 can generate electronic documents, or granthas 250, composed of TextObject graphs (using grantha generator 220). In some instances, external documents or files (e.g., 265) may be linked to granthas 250 (and even composite TextObjects 245) such that the content of these documents can be accessed during drafting of the document and, in some cases, also following the grantha's conversion into a consumable eBook or other document 270. In some implementations, a flexible text production system 205 can include a search engine 240 to construct searches relating to text or structure included in a given document produced using the flexible text production system 205. The search engine 240 can cause searches of corpuses of documents (e.g., 265) to be performed, from which a listing of relevant documents can be returned (and linked to using the flexible text production system 205). A GUI engine 230 can be provided to generate various GUIs and GUI windows through which users can access and interact with modules (e.g., 210, 215, 225, etc.) of the flexible text production system 205.

The narratives which a single writer creates also exist in a fictional universe, but this universe may someday grow, multiply, and connect to other universes. No software available today—in my view—allows writers and readers to model narrative in the large and in the small. No program can connect people who want to connect into a shared narrative universe. An improved system is described herein to provide just such functionality.

In one example, a relational text system is provided to allow the user to track events (along with people and locations); to visualize architectural components of narrative (acts, scenes, etc.); and to relate both of these aspects of story to actual texts—that is, written documents.

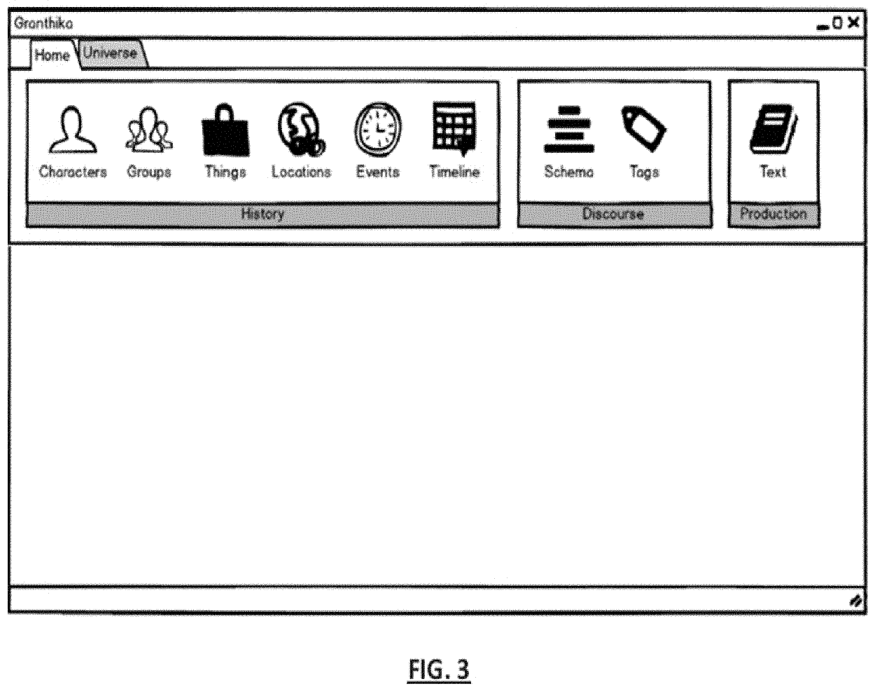

FIG. 3 shows a menu of a GUI generated by the relational text system. This example menu shown in FIG. lays out the elements that the relational text system models and tracks. The “History” group contains the “what” of the narrative, “the content or chain of events (actions, happenings), plus what may be called the existents (characters, items of setting). “8 The “Discourse” group will allow the user to model and manipulate the “how” of the story, the arrangement of elements (scenes, acts, etc.) by means of which the content is communicated. The “Production” group will handle the physical media—books, film—which embody the narrative. An exposition of each of these functions follows.

History

The history (or histoire) of a narrative may be thought of as the what-actually-happened, as the content. It is quite different from the form of the narrative, its discourse (or discours); you could make two quite different narratives out of the same history by choosing different events to dramatize, or by changing the order of the scenes you then create, or by manipulating the mood of the scenes in your discourse.

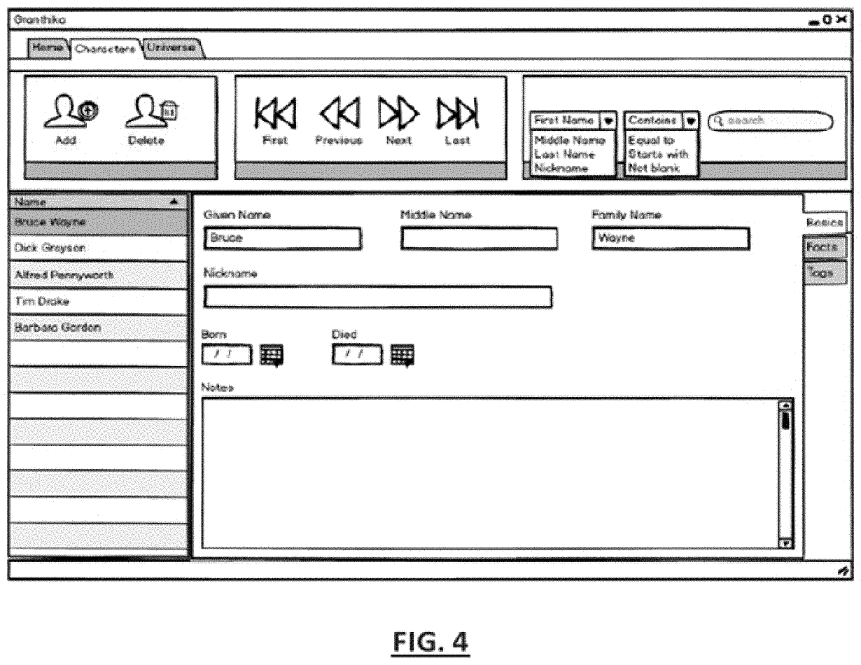

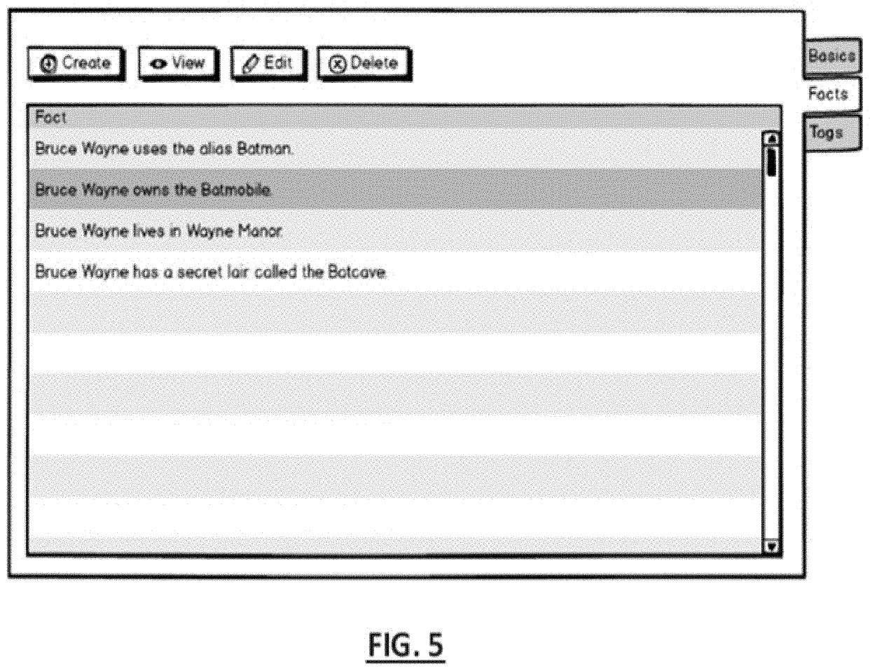

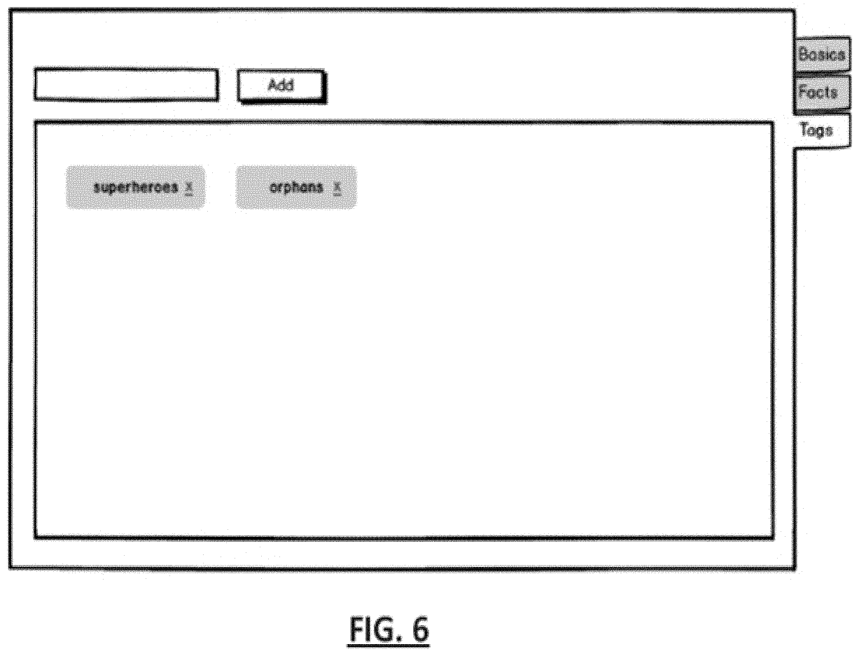

The first of the existents of the history are characters, the entities who act within the world of the story. FIG. 4 shows a view of a Characters panel of the menu through which a user has access to Create-Retrieve-Update-Delete (CRUD) capabilities. The “Facts” panel, however, presents more interesting possibilities. FIG. 5 shows a view Facts panel. Through the Facts panel, assertions about a selected character can be defined, written in a domain specific language (DSL). The user can add as many facts as they wish, and if the fact refers to another existent, the adding of this link is transitive, two-way—that is, if we looked at the facts panel for the Batmobile (which is a “Thing”), we would see something like “The Batmobile is owned by Bruce Wayne.” Further, as shown in FIG. 6, a “Tags” panel can also be provided, through which a user can add tags to the character, and thus attach some metadata to this character.

In one implementation, the Facts DSL of an example relational text system allow the user to describe—in near-natural language—connections between existents. By typing a line of text, the user is able to create a link between Bruce Wayne and the Batmobile; behind the scenes, the relational text system may create a relationship between two records in a database, but the user will never need to worry about those technical details.

A DSL provides a more flexible interface than the conventional one-to-many or many-to-many GUIs that business programs use to allow the creation and editing of relationships (between a customer and orders, or between an invoice and its line items). In a fictional world, it is very hard—or impossible—to predict how a user may want to link existents. We know that characters may own Things, but what if a writer wants to indicate that a Thing (the Batmobile) can sometimes spawn smaller Things (spy drones) when required? Do we then attempt to build a GUI that can handle all the possible permutations that the existents of a story can generate? This is impossible. A DSL grants the user freedom to create whatever connections he can imagine, but also—very importantly—it allows the user to create ontologies. A DSL can provide the user with the ability to model “complex circumstances” with “extraordinary clarity” is essential. This can allow a user to provide contextual knowledge to the entities described by the corresponding text. Through the relational text system an author-user can build their own particular universe, and not struggle to contain the particulars of their existents within an opinionated piece of software. Many current fiction-writing software systems, for example, thoughtfully provide a “Male/Female” field for characters. But what if the writer is creating science fiction in which a species can have three genders, not two? An improved relational text system will allow the writer to imagine such a species.

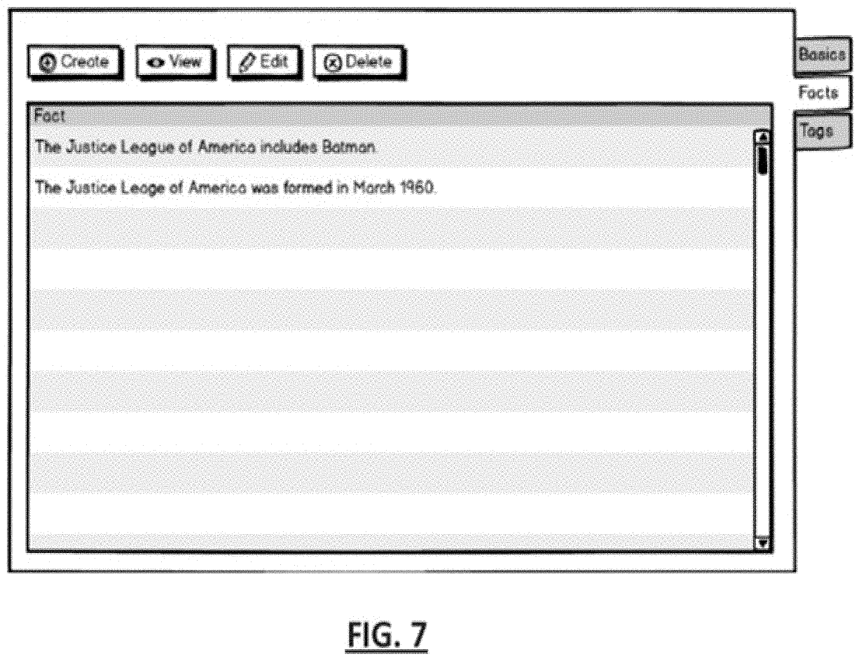

Groups may also be defined as collections of Characters (or Things, or anything else); the writer can use these to model political parties, or families, or travelers on a plane. The “Basics” and “Tags” panels of the Groups tab will very much resemble those for the Characters tab, and provide the same functionality. FIG. 7 provides a view of the Facts panel for a Group. Note in this example that the second fact in this list introduces a temporal element: the date of the creation of the group. Temporality may be built into the relational text system from the ground up, and the system must allow for partial dates. That is, there are some facts that we may not have precise dates for—we need to be able to enter a year, or a year and a month.

In one example, “Things” are definable as inanimate existents within the narrative that the user wishes to track. Through the relational text system, Things can be related to Characters and vice versa, to allow a user to assert, for instance, that “The Batmobile Mk. IV was put into operation on Jul. 23, 2012.”

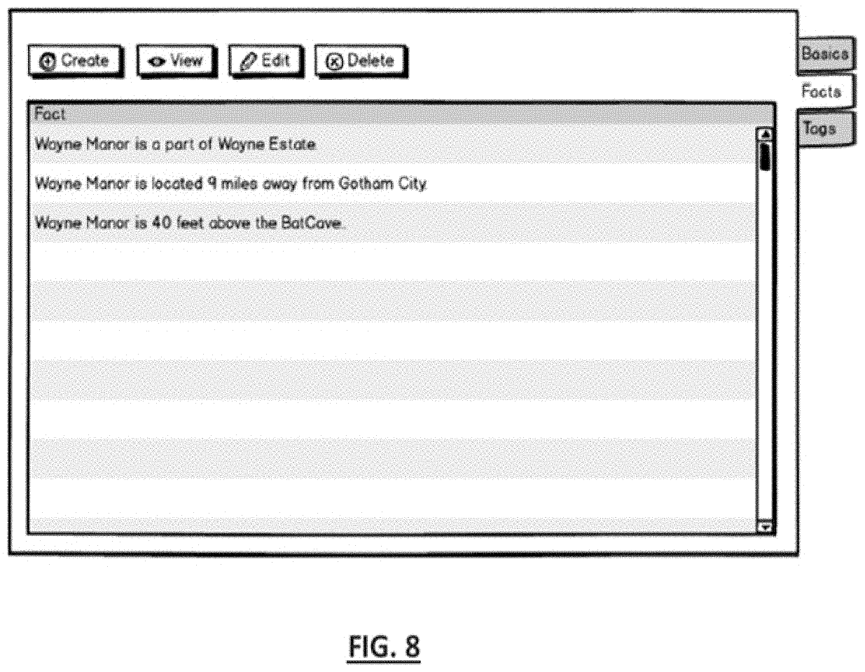

In one example, a relational text system provides for the definition of Locations, and for a particular location the Facts panel will allow a user to relate to other existents, including other locations. FIG. 8 presents a view of the Facts panel showing the definition of a related location. Note, in this example, the assertion that “Wayne Manor is a part of Wayne Estate.” If the user enters a query like “Show me all the scenes that take place on Wayne Estate,” this will allow the system to correctly include scenes that are marked as taking place in Wayne Manor. For the majority of users, this kind of location nesting and the ability to relate locations to each other will suffice. For users who desire more sophisticated geospatial mapping, the relational text system may additionally provide map-editing capabilities—such as those demonstrated by the Google Map Maker—in a downloadable add-on package, among other implementations.

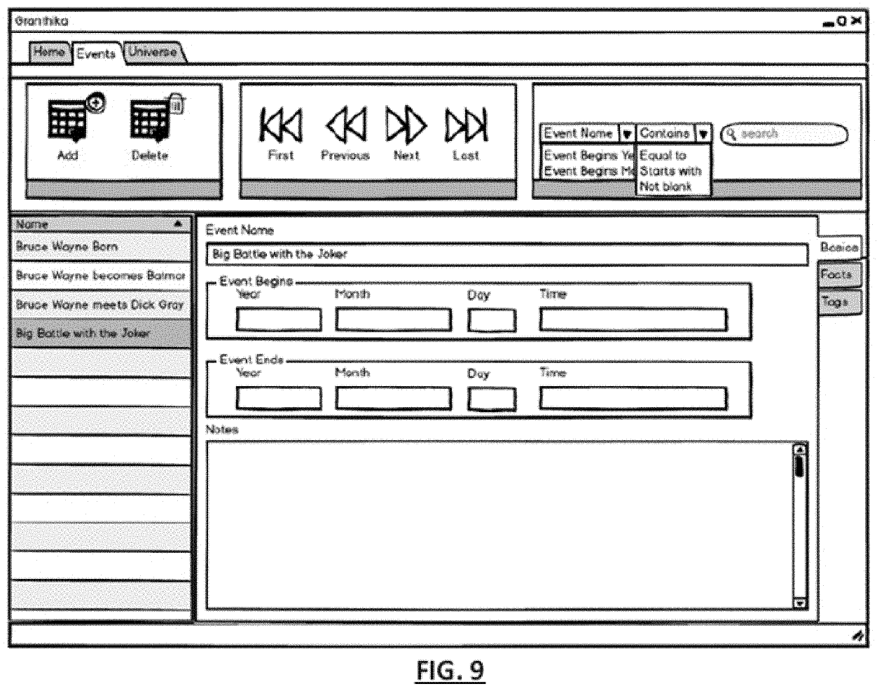

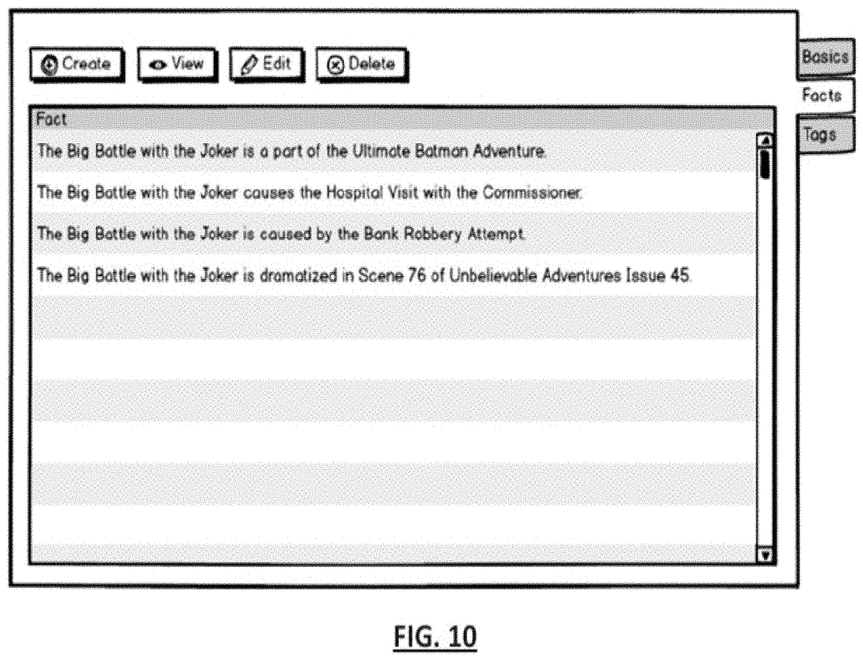

Events are used to keep track of happenings and actions that take place within the narrative. In one example, such as shown in FIG. 9, an event creation window in presented in the GUI with separate fields for the year, month, etc. This allows for the entry of partial dates, proceeding from the most general on the left to the particular on the right. In the corresponding Facts panel, shown in FIG. 10, we can add some sophisticated functionality relating to events created through the GUI of FIG. 9. Further, we can define an event to be part of a larger, continuing event. So, if a user enters a query like, “Show me all the battles during the Hundred Years War,” the system will be able to retrieve all events of a certain type that are marked to be “a part of” the Hundred Years War. We can set up causal links between events, and also indicate that a certain event is dramatized in a particular narrative unit in a text.

Since the nature of an “Event” is defined by the Facts ontology of the example relational text system, we can expect that the system will be able to catch errors: if the user tries to enter a Fact which indicates that an event causes a prior event—such as, “The Second World War causes the Hundred Years War,” the relational text system identify the error and present an error message (e.g., in the GUI) to warn the user. This is where a sophisticated ontology, entered into the system through a flexible DSL, really starts to pay off. The user is, in effect, building not just a number of taxonomies, but also a rule-set which governs how the entities, things, and events within the system interact with each other.

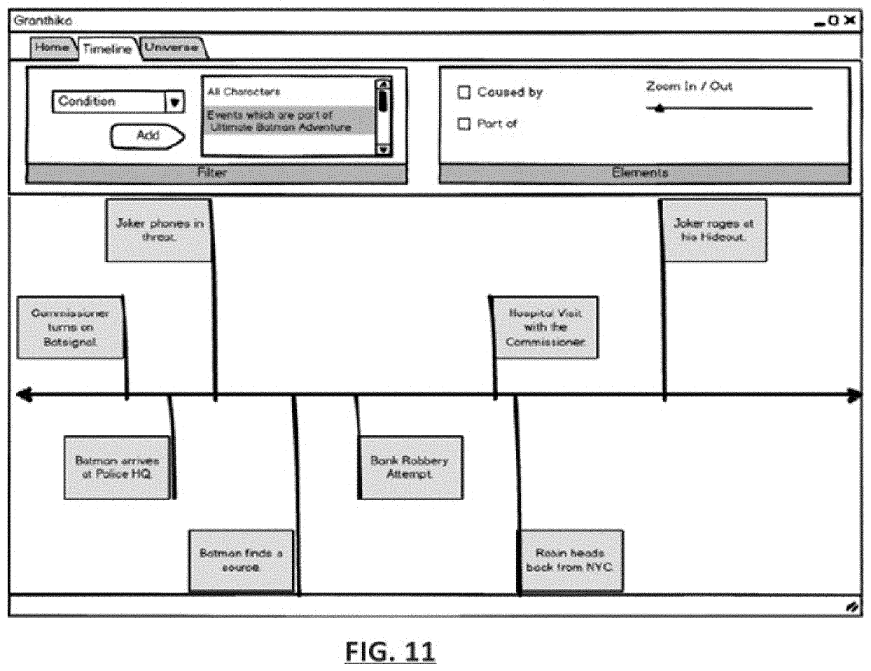

A relational text system can further include a timeline, or visualization of Events, such as represented in the GUI screenshot illustrated in FIG. 11. As represented in FIG. 12, a timeline tool can be used to turn on visualizations of various other elements relating to events, among other features. For instance, in the example of FIG. 12, the “Caused by” option has been selected by a user causing causal connections between events depicted on the timeline (as determined by the relational text system) to be illustrated in the GUI window.

Discourse

As introduced above, each narrative has two parts, “a story (histoire), the content or chain of events (actions, happenings), plus what may be called the existents (characters, items of setting); and a discourse (discours), that is, the expression, the means by which the content is communicated. In simple terms, the story is the what in a narrative that is depicted, discourse the how.”

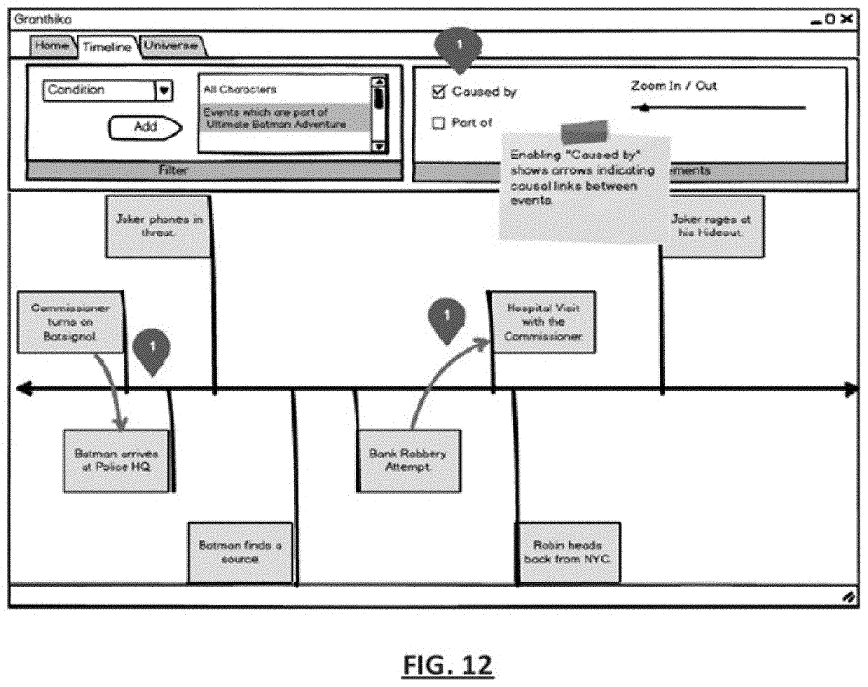

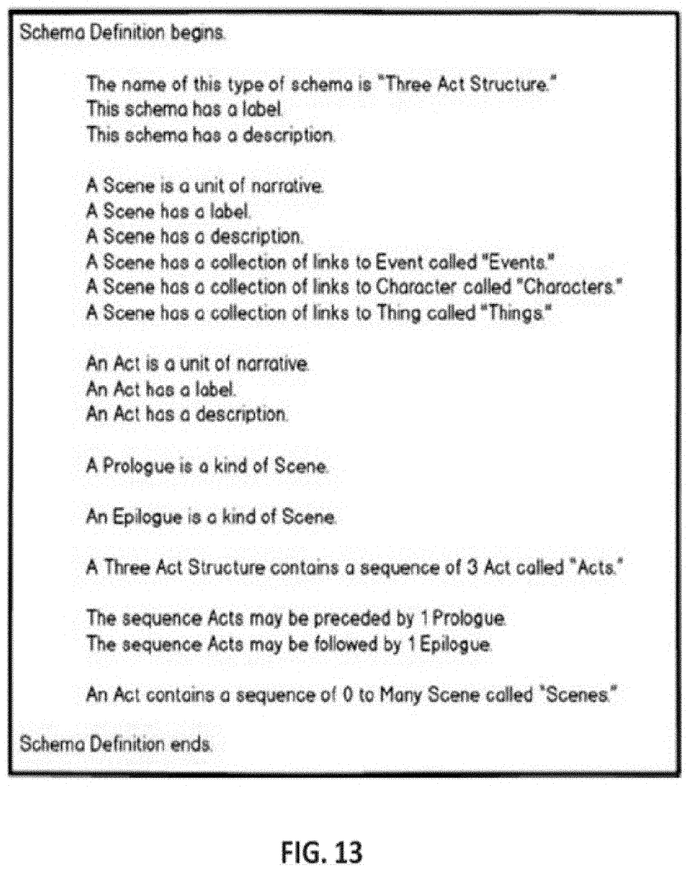

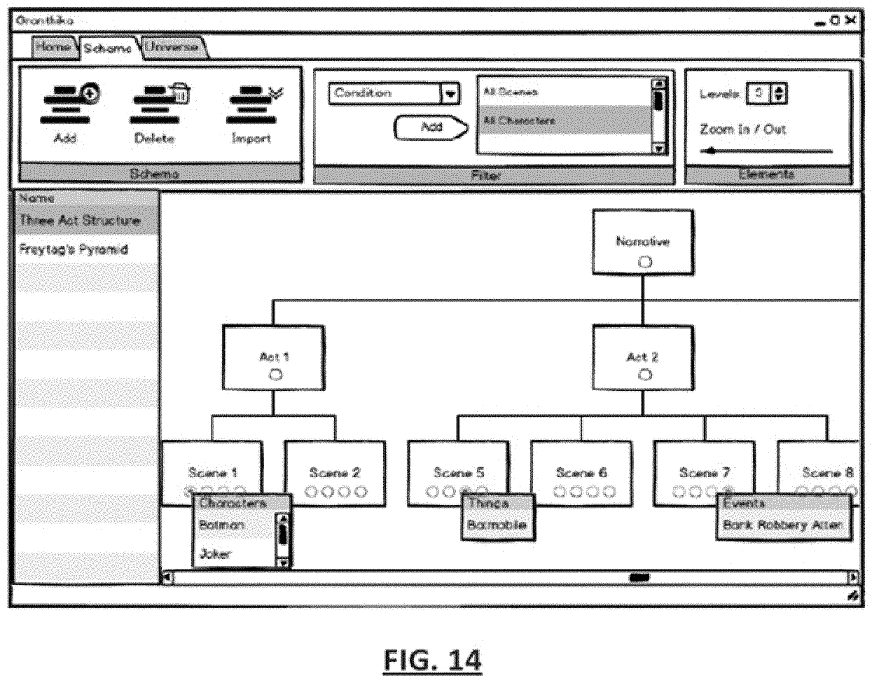

One of the aspects of discourse is narrative schemas, or simply, “schemas.” Schemas are conceptual structures used to analyze narratives. One of the most familiar ones is the “three act structure,” which is almost universally used in Hollywood films. In a typical three act structure, a rising arc of action is followed by the descending action, or resolution after the climax. In a two-hour movie, the first ten scenes may make up the first act, the next forty the second act, with the final ten scenes comprising the third act. Other schema may be applied to a narrative, such as Gustav Freytag's schema of five acts: exposition; rising action; climax; falling action; and denouement. Conventional writing programs with structuring functionality typically use a particular schema by default. The problem is, however, that once this structure is built into the implementation used by the software, it becomes impossible to describe—much less use—any other schemas, of which there are plenty. A film scholar, for instance, may want to use a narrative-act-sequence-scene-shot taxonomy, but will be prevented from doing so, given the restrictions of the platform. An relational text system can allow the user to create new ontologies by means of the Fact system, it will allow the user to create and apply any number of schemas. For example, a three-act schema can be defined in language (built using the relational text system and its GUI(s)), such as illustrated in FIG. 13. The user is then able to create a “Three Act Structure” and able to link Events, Characters, Things, and Locations to Scenes using the relational text system, such as shown in the example relational text system screenshot illustrated in FIG. 14.

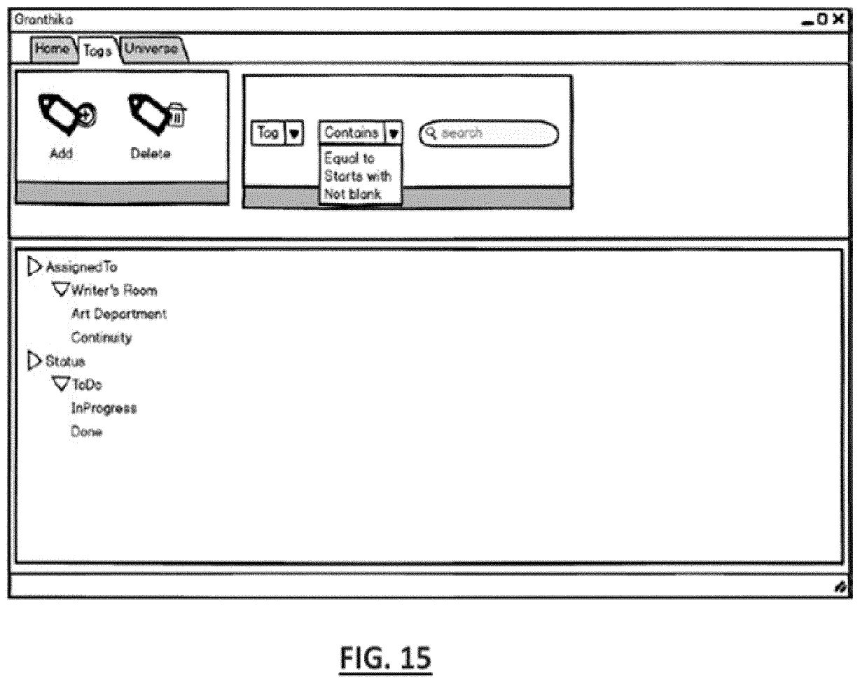

A relational text system can further provide for the use of tags, or tagging, to allow users to attach arbitrary metadata to elements (Characters, Things, and so on). A window of the relational text system GUI, such as shown in FIG. 15, can be provided to allow users to define and apply tags. For instance, the relational text system may allow users to create Tag hierarchies and/or flat Tag structures.

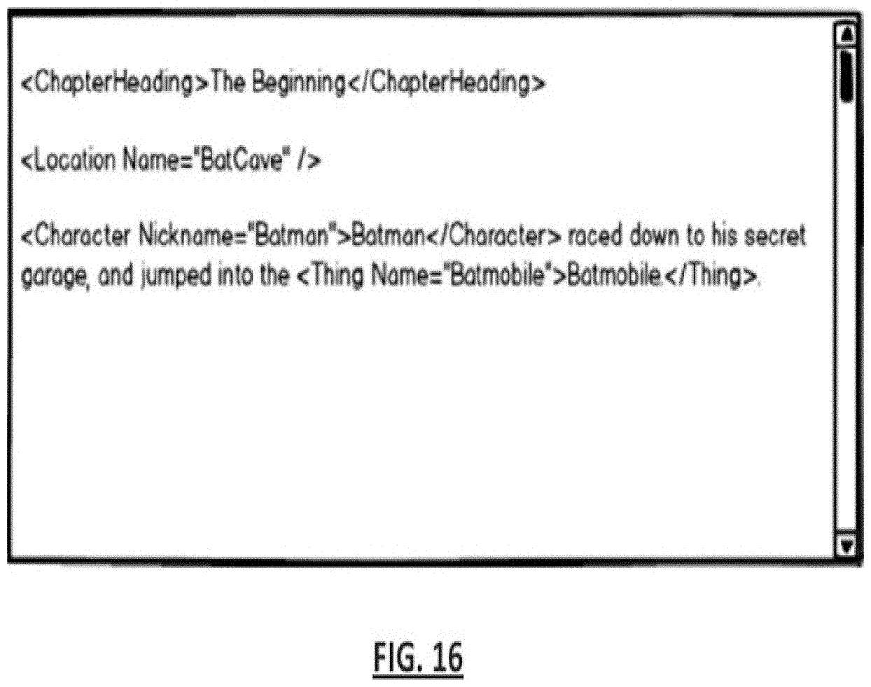

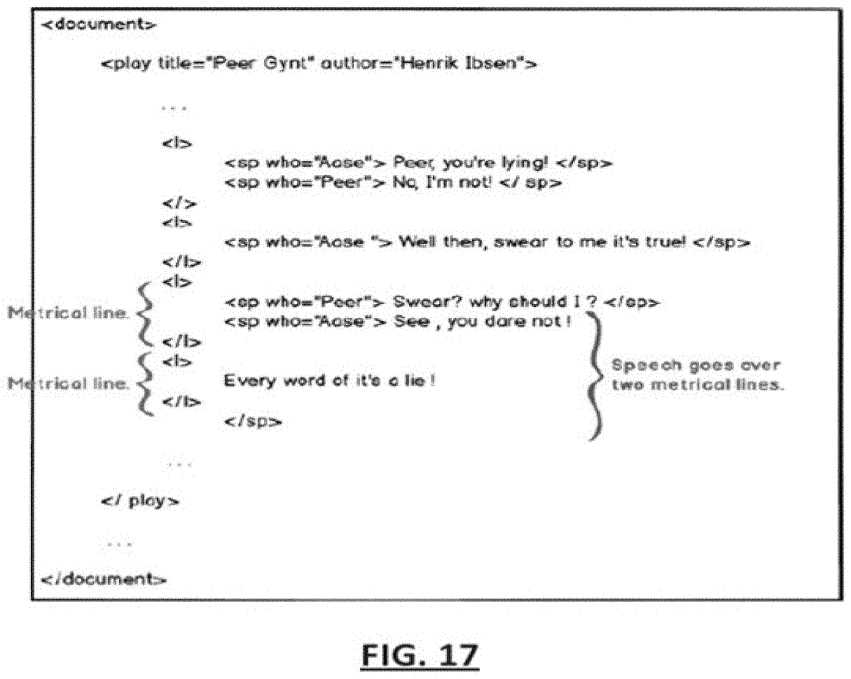

The Text tab of a relational text system may allow access to the actual story or screenplay or novel the user is working on. It is desirable to connect the actual text of the story to all the structures—Characters, Things, Locations, Events, Schemas—such as those already created for analytical purposes using the relational text system. In one implementation, illustrated in FIG. 16, an embedded markup features can be provided through the relational text system to allow associations between these structures to be applied to the text. However, such manual markups are not only labor intensive, but also prone to human error (e.g., accidental deletion), markup language syntax errors, etc. Such problems are not new, as markup languages like SGML and XML have been used to introduce descriptive meta-structures into plain text. These efforts soon ran into the “overlapping problem.” In the following extract from the play Peer Gynt by Henrik Ibsen, for example, a speech (<sp></sp>) extends beyond the boundaries of a metrical line (<l></l>), such as represented in FIG. 17. As shown, an attempt has been made to mark both dramatic and metrical hierarchies; the problem is that the dramatic and metrical hierarchies are not related, and so the respective tags are not hierarchically nested. Since XML allows for the representation of only one hierarchy in a well-formed document, this results in an invalid XML document. XML-based Text Encoding Initiative (TEI), for instance, has attempted to deal with the problems of overlapping hierarchies through numerous, complex techniques: milestone elements, which are empty elements that mark beginning and end points; partial elements, which use syntactic conventions to indicate fragmented sequences; and redundant encoding, which just uses different copies of the same document to mark different hierarchies. The result is an incredibly complicated definition; TEI is in its fifth major revision, and now contains more than 500 elements. These problems seem to arise from two fundamental errors: trying to cram what is essentially a multi-graph structure into a single tree-like hierarchy; and treating digital text like its print counterpart.

Well-formed markup documents allow for the creation of a single tree or graph of meta-data within a document (e.g., a directed acyclic graph). But a text can require multiple graphs: one for text markup, another for structural elements, and so on. Variations on XML's single-hierarchy model have been proposed, such as the definition of the standard GODDAG (General Ordered-Descendant Directed Acyclic Graph). The question of how to model text—that is, the Unicode characters and other artifacts that are actually scanned visually during reading—has proven to be more intractable. Typically, programmers think of digital text as somehow “plain,” unadorned; embedded markup introduces visual and conceptual transformations into tag-contained sequences of text, but the characters themselves are thought of as minimal primitives. Documents can be thought of as a manipulation of “arrays of chars.” One can see why this might be: the very words “typeface” and “font” come from the age when print was produced by pressing metal letters onto paper; both the visual marks and the machinery that created them were very simple. This simplicity extends into the digital world: an e-book comprises sequences of simple characters (perhaps interspersed with pictures, etc.) formatted by embedded markup (perhaps in conjunction with standoff elements like stylesheets). This surface which we read is (apparently) stable and simple, like ink on paper. Documents of electronic text, such as e-books, are sometimes described as electronic imitations of the static printed page.

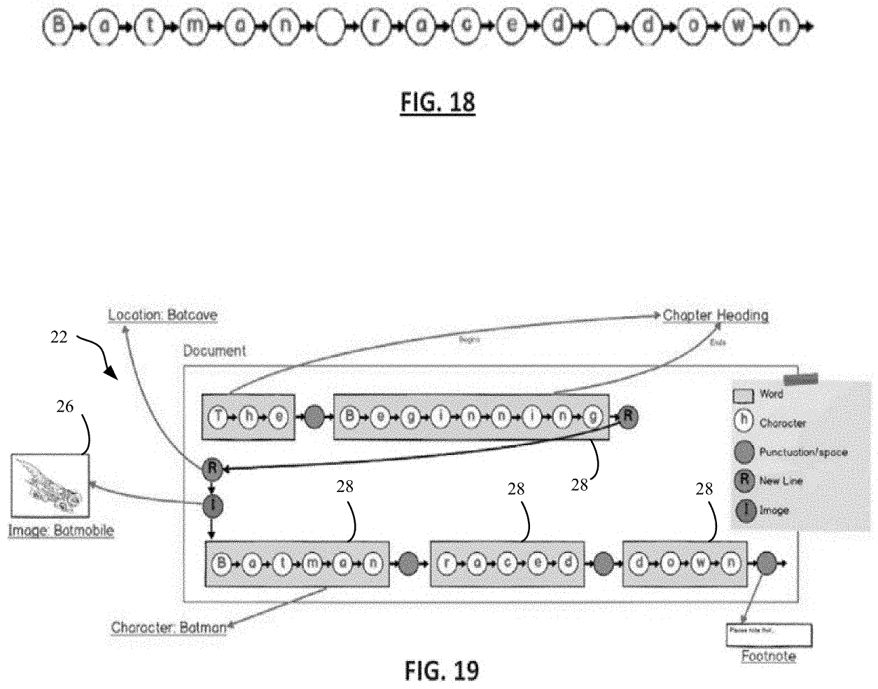

Modern mark-up definitions tend to be structured consistent with the manner in which programmers think of characters and text. For instance, pages served up by our browsers comprise HTML structures that combine streams of characters interspersed with tags; the tags add information to “dumb” characters and change their display and their behavior. But even behind the surface of the HTML page, at the server end, characters themselves are regarded as simple structures, primitives. In an improved markup language, the text of a document is considered and treated as a graph, a series of vertices (nodes) connected by edges (or “arcs”) (such as represented in FIG. 18). The use of such a graph structure can address, in an efficient fashion, the problem of overlapping hierarchies. A data structure can be created for individual text characters that allows the linking of one character to the next. Other useful properties may then be linked to such a structure.

In one implementation, all text of a relational text system is be represented by instances of the class TextObject and its subtypes, contained within a document. As represented in FIG. 19, in a relational text system, a word is a TextObject that contains a sequence of TextObject instances. A space is a TextObject. A period is a TextObject. Each letter is a TextObject, and so on. As a result, text can be treated as a graph, and vertices within this graph (characters, punctuation, and so on) can be linked through edges to objects that lie outside the text portion of the document (instances of the relational text system's Event, Character, Schema objects). Accordingly, meta-data can be attached to the text of a document without unduly disturbing the integrity of the document itself. Further, elements belonging to different hierarchies—the schema, the timeline—can be related to portions of the text without difficulty. Thereafter, queries can be constructed across these various connected graph segments (schema, timeline, text), for instance: “Find all the scenes that take place on May 23, 2011 and show me their associated text segments.”

Since the document is itself a graph model (e.g., a hypergraph, directed graph, etc.), other elements can be added inline or as metadata associated with TextObjects-links to images, footnotes, etc. can be embedded. Since the graph of the document is not what is shown to the reader, the decision of how particular elements will be displayed on the reader's screen can be deferred. That is, in the actual surface designed for reading (as opposed to writing), footnotes can be shown at the bottoms of pages, or in a popup window. Clicking on an endnote may show the associated text in a hovering window, or jump to the end of the document. Within an endnote, a button could bring up the bibliographic listing with links to the actual book or paper on the web. We could also allow the reader to decide how each element is displayed; the reader could configure each document according to their preferences, among many other example features and use cases. The possibilities are endless. A relational text system can include a text editor that facilitates the construction of such documents: the ability to annotate texts with links to other elements of the relational text system should be easy and seamless.

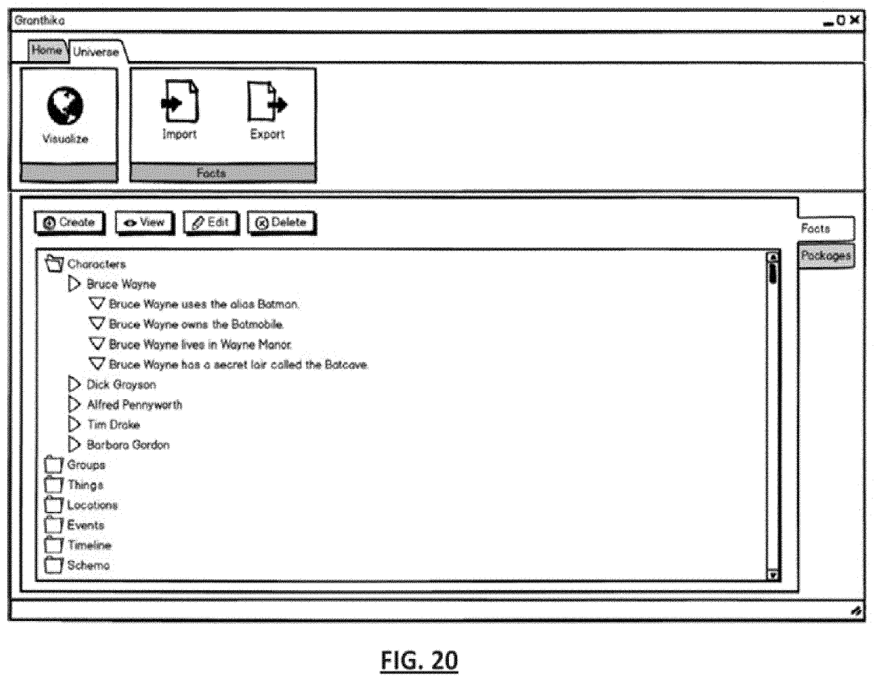

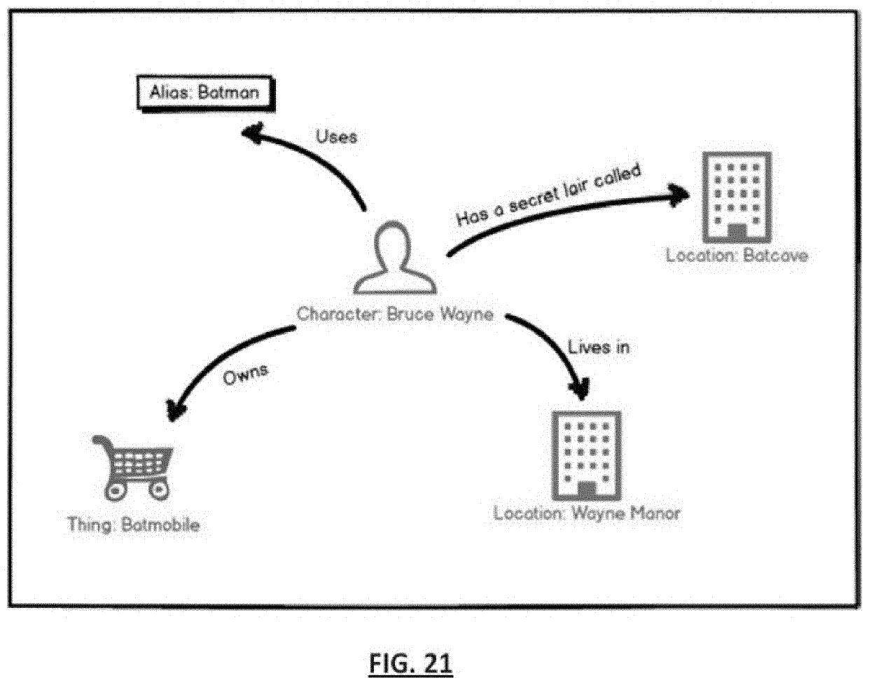

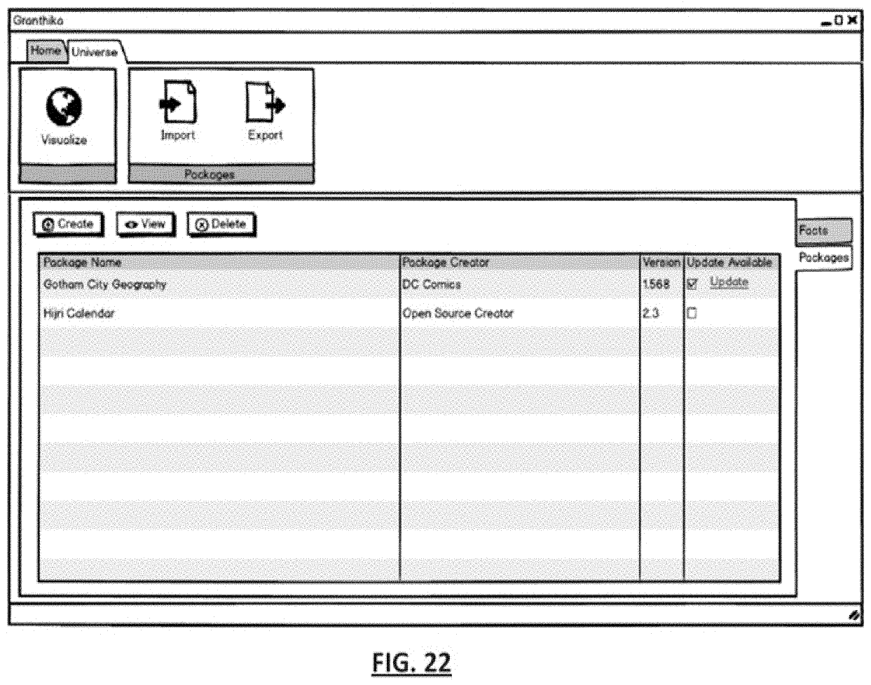

A document of text composed with TextObject instances can be referred to as a “grantha.” The grantha may contains all the meta-intelligence to associate with corresponding text—that is, the universe structure, schema structures, the ontology, the relationships between characters, and so on. A Universe may model the “world” (e.g., people, places, things, and their respective characteristics and interrelationships) described by a document, while the schema may model the structure (e.g., chapters, sections, format, narrative structure, etc.) of the document. As shown in FIG. 20, the “Facts” section of the Universe tab gives the user all the Facts which constitute the world of the story. Facts can be imported and exported. The “Visualize” function may allow the user to observe and manipulate facts in a graphical manner, such as represented in FIG. 21. Facts can be exported into a “Package.” As represented in the screenshot of FIG. 22, a Package can constitute a collection of Facts that the user herself or someone else has created. Packages can be imported as self-contained units. Once a Package is imported, all the Facts in it are added to the Universe of the grantha and become active and accessible to the user. In the example of FIG. 22, the import of two Packages has allowed the Universe of this narrative to become aware of the geography of a city and the Hijri (Islamic) calendar. The user will now be able to place events at specific locations in that city, and use the Hijri system of dating (e.g., within the timeline). Further, the relational text system can provide a central repository to allow the creator of a Package to issue updates, which could then be provisionally downloaded and applied by users.

A relational text system's metadata and Package system can enable some intriguing features and applications. As noted, the relational text system can use TextObjects to construct texts and further allow the system's user to add metadata to any level of the text. The relational text system's Fact system enables intelligence to be embedded into text, with the user able to construct ontologies, relate objects to each other, and so on.

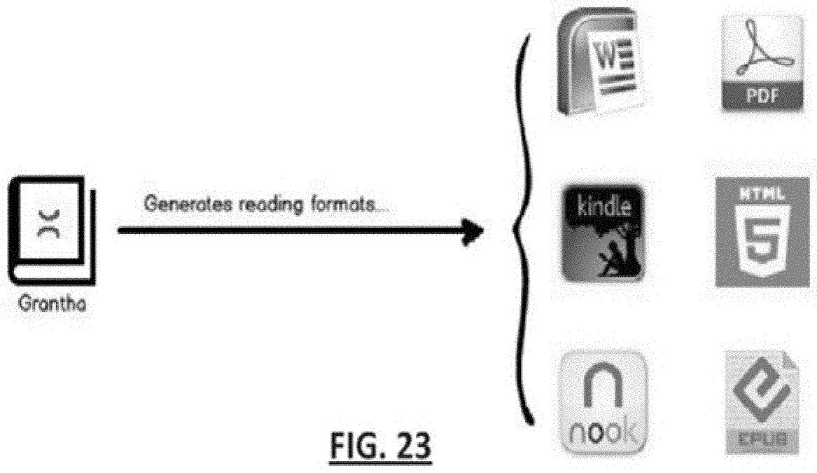

A grantha, rather than a traditional text document or eBook, can be considered a writer's tool, which the reader never sees. A relational text system is a software artifact that the relational text system may use to generate eBooks. A grantha makes it possible for the writer to produce eBooks in many formats, such as represented in FIG. 23. A grantha is a structure that contains the text of a narrative and also metadata relating to this narrative. The user of a corresponding relational text system may generate a readable format—a PDF, Word, or other document format, for instance—from a grantha. More advanced files and enhanced presentation formats may also be generated from a grantha, such as augmented reality presentations (e.g., virtual reality presentations, enhancing a reading surface with visual or audio effects corresponding to content of the text presented on an e-reader device (e.g., the sound of rainfall when an eBook “page” describes a rainy scene), among other examples). Indeed, the metadata of granthas may permit the storage and implementation of knowledge, executable programming scripts, files, etc. to support such enhanced presentation functionality.

In one example, the grantha format may be used to generate a proprietary eBook format. Such an eBook format may constitute a specialized reading surface with certain capabilities built in. For instance, the relational text system can facilitate creation of a display surface, which—because it is interacting with a graph of smart TextObjects—will be able to easily encompass a range of functions that are not currently available in any reading format.

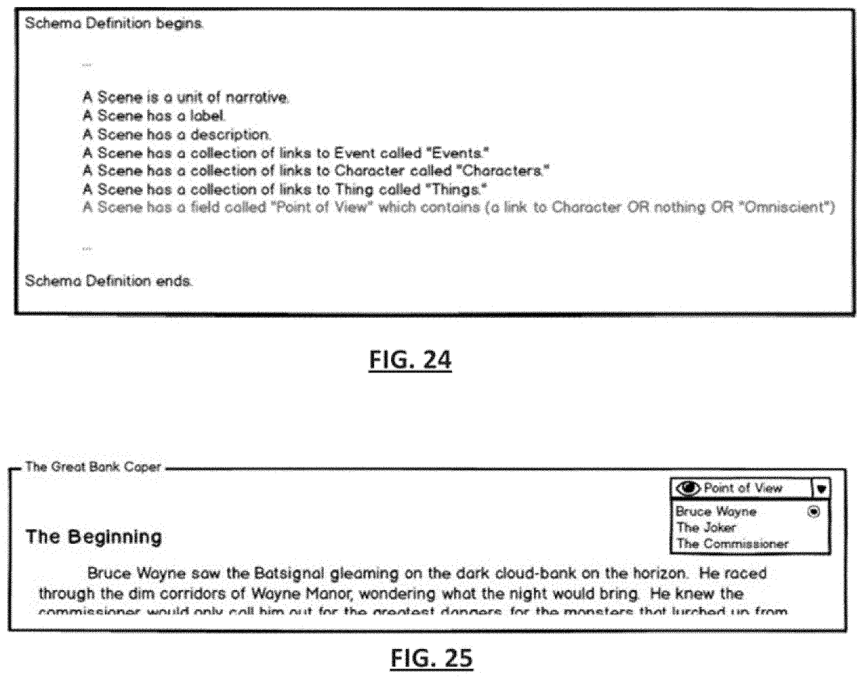

In the example of FIG. 13, the relational text system schema definition provides functionality to define scenes and acts within a narrative. An amended schema definition, such as represented in FIG. 24, can show the definition of a point of view for every scene in the narrative through the schema. Given this metadata, a UI can be provided that presents an eBook authored using a grantha of the relational text system and further allows the user, through the grantha, to selectively and dynamically switch points of view dynamically (e.g., using a GUI tool such as represented in FIG. 25). A single grantha-based eBook, therefore, can contain multiple inter-twining narratives. The reader could experience the same text in different configurations. The possibilities of multiple points of view would be limited only by the author's creativity.

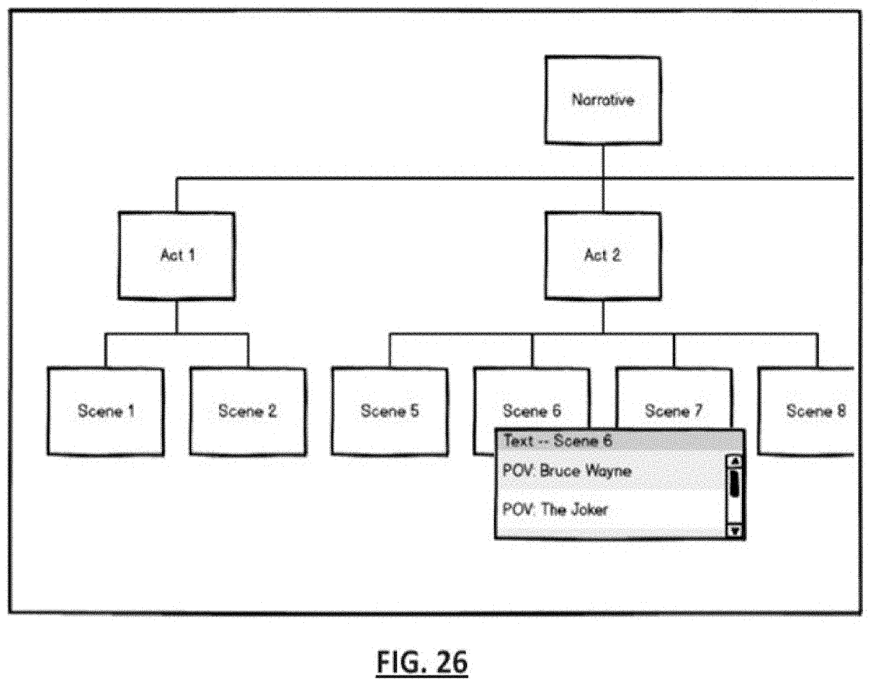

So we may have very complex narrative structures being produced through an example relational text system, but from the author's perspective, all these different pieces of text are easily managed in a unified way through the system, such as through a GUI similar to that shown in the example of FIG. 26.

In another example, a relational text system can be used to facilitate the development of collaborative narrative works. For instance, a relational text system can be used in connection with the development of fan fiction. In some instances, fan fiction is to be authored consistent with content guidelines developed by the owners of the intellectual property upon which the fan fiction is founded. For instance, fan fiction developed around the Veronica Mars television series is to be developed such that “Stories must be based on characters, scenes, events, themes and plots appearing in the Veronica Mars television series only, which ran 64 episodes from 2004-2007. The World does not include characters, scenes, events, themes or plots that are unique to any books, movies or other derivative works based on the Veronica Mars television series.” Often to work against this backdrop, or any other canonical narrative, a writer has to absorb an immense amount of information and comprehend all the links between characters and events. The relational text system possesses functionality to facilitates the construction of Universes that can be packaged and exported. Accordingly, using the relational text system, ready-made structures compliant with the guidelines set for various canons can be developed for fan fiction writers to work with, to check facts against, to study and extend. A creator of any narrative in any media—fiction, film, television—would be able to provide a download link for their canon. Since each Universe is versioned, when new information is added—say, an additional episode is released by the creators—fanfic authors would be able to update their local versions using the relational text system. For instance, should a character dies on a TV show; by downloading the latest version of that show's Universe, fan fiction writers would be able to have their local versions of the Universe updated with the death and all the subsequent events, and such updates can be made dynamically.

A relational text system can permit the addition of a Universe generated by the relational text system. Accordingly, such functionality of the relational text system can enhance the sharing of such ideas. For instance, users can collaborate on adding specificity to a Universe. The relational text system can further allow content creators to keep track of their own narratives, which is no easy task, especially in today's media landscape, in which a television series can run for eight seasons and video games release new expansions every year. This can be further complicated by the reality that readers of such fan fiction can become fanatically particular about details included in these works. A relational text system can allow fans to pool their insight into an established or developing cannon to allow a cannon and its Universe to be continuously developed (e.g., through crowdsourcing of such information from multiple users of the relational text system who may collaboratively annotate and detail various corresponding Universes.

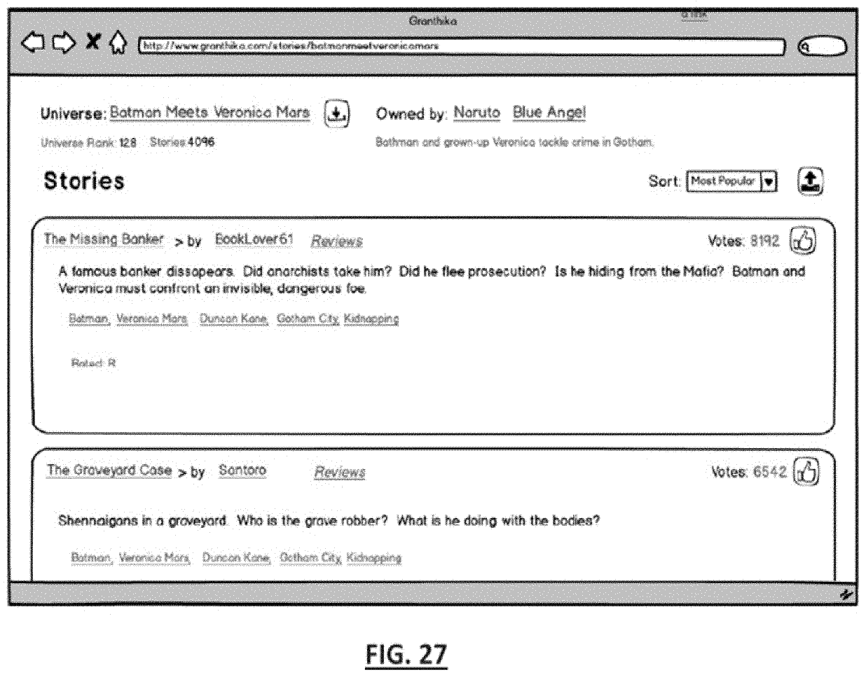

In another example, multiple users may utilize a relational text system to write new stories based on a shared universe. The creators of a shared universe can thereby import stories into their universe. Such as shown in the example of FIG. 27, different users (e.g., “Naruto” and “Blue Angel”) have created a “shipping” universe (“shipping” refers to the fan practice of connecting two or more characters from different shows or books). Users “BookLover61” and “Santoro” have both created stories within this “Batman Meets Veronica Mars” universe. Other users have up-voted “The Missing Banker” by BookLover61 to the top rank of this universe. Now, if the owners of this universe so desire, they can import “The Missing Banker” into their canon. This would mean that the characters, events, and other existents within “The Missing Banker” would now become part of the official “Batman Meets Veronica Mars” universe.

In this way, individuals may utilize the relational text system to contribute to a growing web of stories. One could imagine the creators of a television show holding a competition for user stories. In addition to other rewards, the winning story would be incorporated into the television show canon. Fans could thereby become co-creators.

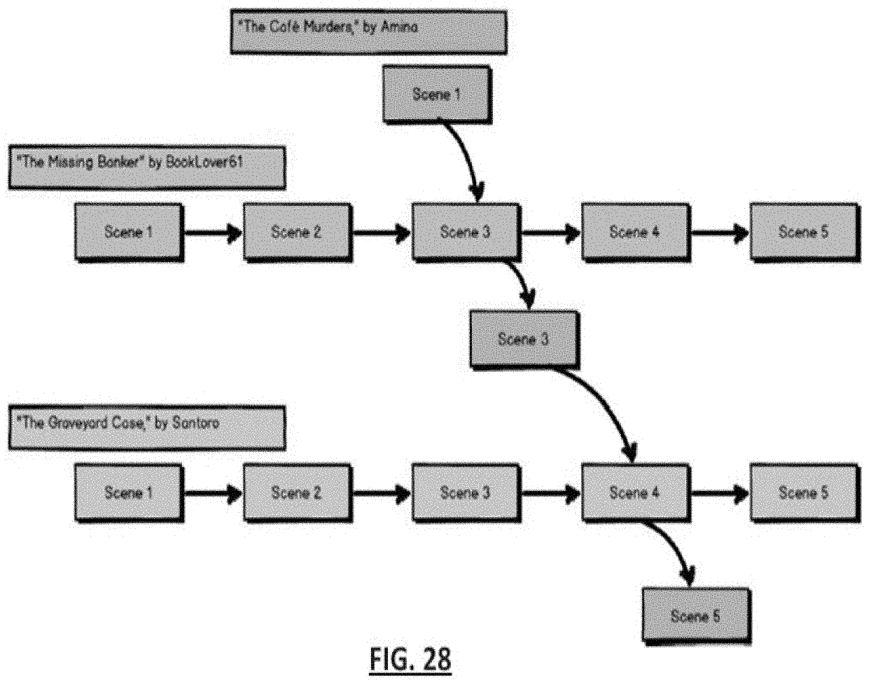

In an additional example, a relational text system can be utilized to facilitate the development of documents for mashup storytelling. Since stories may be based on a shared universe in an example relational text system, a user could combine scenes and narrative arcs written by other people in their own story. For instance, as shown in the example of FIG. 28, users BookLover61 and Santoro have written stories based on the “Batman Meets Veronica Mars” universe. When user Amina writes her new story set in this universe, she will be able—if permitted by the creators of the material—to freely import scenes from their stories into her own. For instance, in the particular example of FIG. 28, scene 3 from BookLover61's “The Missing Banker” becomes scene 2 in Amina's “The Café Murders.” Accordingly, in such an example, a cosmos may be developed in which numerous creators can collaborate to create and expand multiple networked lines of narrative. Beyond the shared narrative elements, a networked history of events, of characters and dates and times and locations are also maintained. Accordingly, using an improved relational text system, it is possible for a user to create a new story just by importing scenes from other stories, by finding a new path through the network of narrative.

Use cases outside of fiction can also make use of a flexible text-production system provided by a relational text system, and the specialized eBook format enabled by the relational text system. Such a system can effectively provide an intelligent word processor, database, and knowledge enhancer. The relational text system can thus enable the following use cases.

A user wants to work on a new non-fiction book. The user starts the relational text system, clicks through “File/New” and chooses the template “Non-fiction Book” to base your new document on. This template imports a schema of the relational text system that comprises all the structures that are used in non-fiction books (chapters, sections and sub-sections, bibliography, index, etc.).

This brings you to a new screen presenting a view similar to what would be seen in a standard word processor like Microsoft Word. But in the background, the relational text system has created an entire superstructure from which to work: the Universe for “Non-fiction Book” may contain an ontology that describes cover pages, copyright pages, and so on. Using the relational text system, a user can right-click, choose a marker for “Chapter” and type a title, and begin to write.

The user may write: “Bob Kane created the character Batman in 1939.” Recognizing that more information is needed, a user can then open a “Research” window. For instance, a relational text system may include search functionality to run or initiate a search (perhaps “Bob Kane created Batman 1939”) and return a ranked series of articles and reference materials. One of the documents returned in the list may be selected by the user and thereby linked to the user's document (which can be accessed through the document link).

The year “1939” can be selected and “Create event” can be selected by a user in a GUI of the relational text system. For instance, a popup allows the user to create a record in the timeline for “Bob Kane creates Batman.” The user can then highlight “Bob Kane,” right-click, and select “Create person.” After saving this record, in the tool window to the left, the relational text system may prompt the user: “Do you want to connect the person ‘Bob Kane’ to the event ‘Bob Kane creates Batman’?,” from which the user may click “Yes.”

The user can remember a saved article about an uncredited Batman co-creator. The user can open a tool window marked “Files.” The relational text system has already run a search in memory for “Bob Kane create Batman 1939,” to present the user with a preview of a PDF file that contains the necessary information about the co-creator. From this PDF. The user can then drop a link-marker into the user-author's own document, such that, from now on, this marker will open the PDF file. The user can further add a note in connection with this link and/or may link the record to one or more events, etc.

Tool windows of the relational text system show the user information from the internet and saved files. The user can either have these windows update automatically as the user writes, or update them in response to a user's mouse click or key command.

In another example, a user, after months of work, may have written 200 pages, but then decide on a different structure for the book and move some sections around. This can be accomplished, through the relational text system, which creates a new branch in which the user can experiment with the draft without fear of data loss or other glitches. The user can effectively try out the new structure, decide if it is preferable, and merge this new parallel structure back into the main branch. Any changes made would then show up in the main branch.

In another example, researcher-users participate in a collaborative document through a relational text system, in which multiple users may link documents and add information.

Through the relational text system, an author builds a collection of knowledge naturally as a corresponding document is written, by creating markers and links. The relational text system helps the user to find data and accumulate it, add meta-data to it, and link it all together in a meaningful way. Behind the surface of the text that the user ultimately publishes in a Universe of the relational text system—a web of meaning.

A relational text system can allow collaboration such that multiple authors may work to author a single document, in which change made by any one (remote) may be swiftly and painlessly downloaded and merged into another user's local draft. Indeed, a relational text system can enable simultaneous, live editing of a document while using a rich client, which provides more flexibility and power than web-based interfaces.

A relational text system can also be utilized to enhance journalistic writing. Journalists of course work collaboratively with other journalists, editors, and researchers. They also typically need to keep track of facts, dates, and references as they construct a narrative. A relational text system can allow journalists to easily keep reference materials at hand, while also allows the writers to construct timelines and relations between the various actors in the story they are writing. Once the story is written, the relational text system's ability to generate the text in various formats will allow for swift integration into the multi-media reporting that is becoming increasingly popular. The relational text system's ability to generate a text substrate that is amenable to the attachment of external elements at a very granular level would allow a much more intimate melding of media. As the relational text system can address sentences, words, and even characters at an individual level, the text and images and sound can interact with each other, instead of only existing in a kind of explanatory counterpoint.

Natural Language Processing (NLP) can utilize graphs generated through a relational text system. The text in a graph created using the relational text system, can be used by routines of the relational text system running “behind the scenes” to apply machine learning and semantic analysis to the text as it is being written. Once we begin applying intelligence to the writer's output, many benefits will follow.

Above, schemas provided by the relational text system are described for the purposes of writing fiction (three-act structure, etc.). However, as the relational text system may allow the user to define any structure, users may utilize the relational text system to construct appropriate schemas corresponding to writing magazine articles, textbook chapters, how-to blog posts, etc. In each schema, the relational text system stores the respective elements of the document (e.g., text, pictures, videos) as elements of a graph. Then, using the capabilities of specialized reading surfaces provided by the relational text system's eBook format, these elements can be exhibited in spectacular ways. For instance, a standardized reading surface in a tablet app may be provided with the following capabilities.

It exhibits linked elements (footnotes, endnotes, other texts, videos) on the screen simultaneously with the main narrative on user request. That is, these secondary elements are shown when the user clicks on a link in popup or persistent hovering windows, or in split screens.

The user can choose which elements of a text are to be shown on the screen. So, just as a reader of a novel may choose to view the narrative from a variety of points of view, the reader of a long journal article could choose to read only the abstracts of the sections of the paper.

Since the writer of a text through the relational text system has the ability to link in external resources at the time of composition, those resources become available in frames simultaneously.

If the reading surface allows the reader to comment on portions of the text and also create links to external resources, the text becomes the basis for a reader-created palimpsest. One could imagine collaborative reading—students in a literature class, for instance, annotating a novel.

Given these capabilities, the text becomes more able to transform itself, and to take advantage of the digital media.

While the writers of books, articles, and blog posts, may mainly take advantage of an example relational text system's schematic capabilities and digital possibilities, the temporal and ontological aspects of the relational text system's fact system would be of use to anyone trying to keep track of people and events in time. Although there have been some attempts in academia—especially in the humanities—to provide the ability to easily construct timelines, there is no existent software that allows users to easily relate time, text, and location. After all, creating a fictional narrative is not in essence different from creating narratives about real people and real events. For any kind of writer, describing data and being able to model dependencies, causalities, and possibilities is a prerequisite to telling a story. There is no reason that non-fiction writers would not be able to use the relational text system to construct histories.

Once the data is gathered and modelled, the user will also be able to query it to produce information. You could ask, for instance: How many times has Mr. X been in Budapest in the last two years? Have Ms. Y and Mr. X been in the same city at the same time? External analytical tools could be pointed at the data to produce insights.

The advantages of specialized reading surfaces are also considerable. An enhanced eBook format based on relational text system's output could keep track of how far readers progress into a text, what pages they linger on, what portions they highlight. As noted above, if the eBook allows annotation, knowledge provided by users could filter back into a centralized repository. Text produced using the relational text system text is not primitive (in the technical sense) and passive; it is active.

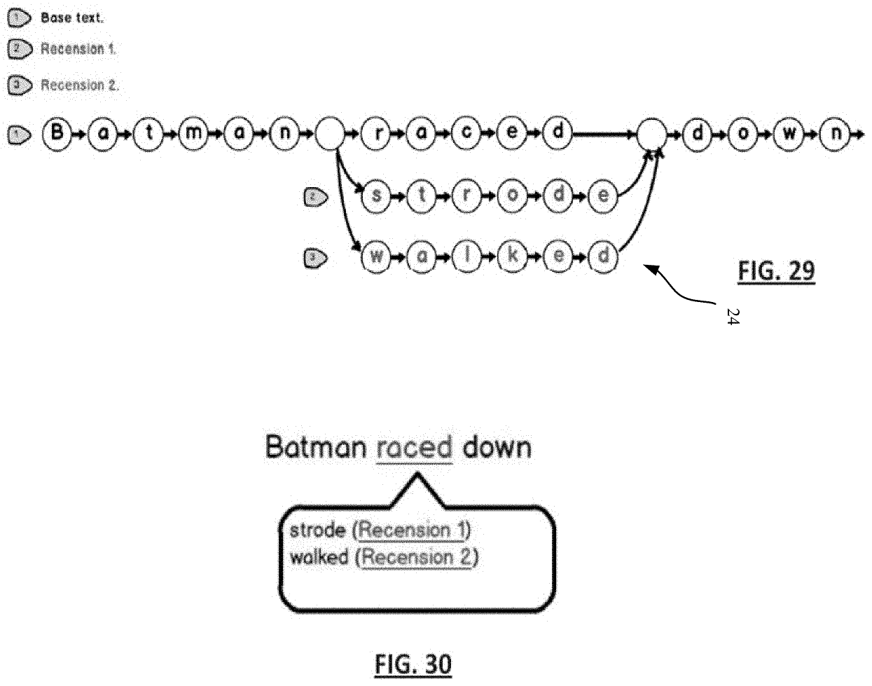

Before the standardization afforded by printing, textual works existed in many versions. Over the centuries, a number of tools have been developed to embody this variance of a given text. A relational text system can also facilitate the retention for such variance, all within the same document, such as the variance illustrated in the example of FIG. 29. Further, the relational text system can provide a GUI tool, such as illustrated in FIG. 30, through which a user can view and pick-and-choose the portions of the various versions to include, or be presented, within the document.

The underlying model of the narrative work generated by a particular relational text system may combine several ideas from the fields database management, knowledge representation and textual markup. At the core of the model is an extension of a knowledge representation formalism, or labeled ordered, hypergraphs. A hypergraph model offers several important generalization over a conventional graph structure: 1) An edge can connect any number of target nodes, not just 2. 2) An edge can also connect other edges. Such meta-edges can be layered at arbitrary levels. And 3) Any edge or node carries a strongly typed value where types are themselves represented within the graph structure. Types are analogous to a schema in traditional RDBMs.

The notion of a single, self-contained document file is replaced with that of a subgraph of textual elements upon which layers of structured information are added as part of a larger semantic graph. Externalizing any part of this highly structured content in a conventional computer file serves only temporary purposes such as network transmission, importing into third party tools or similar needs, but is never the final target. Granthas generated from such structures are not necessarily entirely self-contained because they may be linked to a larger fictional universe maintained as a formal knowledge base in a distributed hypergraph database.

In some cases, each part of the textual content, in its raw form, is identifiable-on-demand (ICD). In other words, a single character, or a sequence of characters (contiguous or not) acquires a universally unique database identifier as soon as a relevant operation is performed on that piece of text. For example, suppose in a work of fiction, the author types a plain sentence:
Sentence 1: The strange encounter between Matthew's cousin and his then girlfriend occurred at the most inopportune moment.

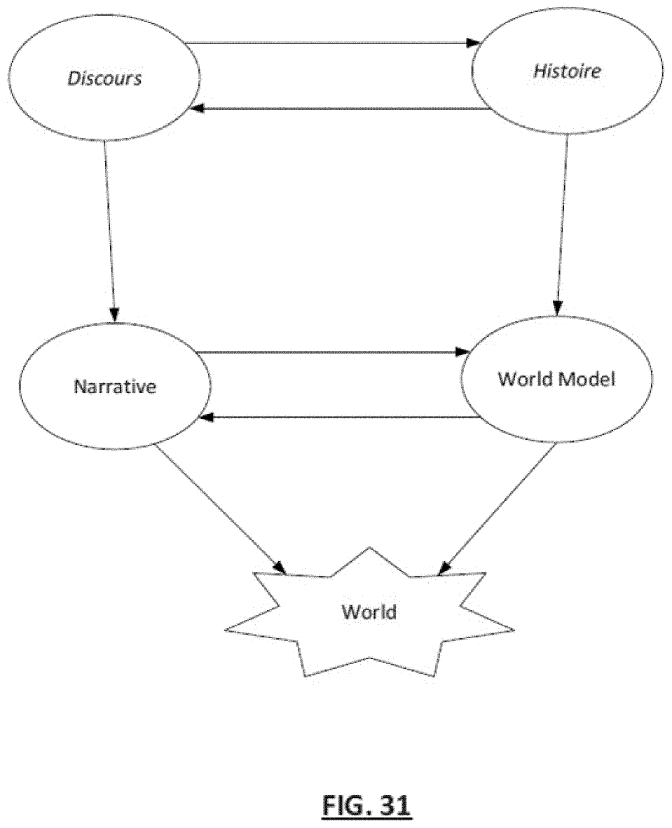

At first, sentence 1 is simply a string of characters that represents a sentence. In the database, it may be stored as a sentence entity with identifier ID0 connected to its preceding and succeeding sentences in its paragraph through a hyperedge, having as value the plain string of characters. However, if the encounter mentioned is an important, pivotal element of the narrative, an author would describe that event as a semantic entity, say E1 with the appropriate attributes pertaining to an event, such as time, place and causal links with other events, as part of the histoire (i.e., story and discourse). The author would then be able to connect the substring “strange encounter” with E1. The connection happens by first automatically transforming the sentence into the following tuple/hyperedge: [ID1:The, ID2:strange encounter, ID3: between Matthew's . . . moment], and then by adding a fact to the database stating that E1 is mentioned as ID2 (i.e. that the textual database entity universally identified by ID2 refers to the real world event described by the semantic entity E1). Thus the text sits within a semantic context all within the same integrated knowledge representation database. Note that the original sentence keeps its ID0 identifier so any references to it remain intact. And it is important to note that from a software design perspective each textual element, however complex, however dispersed in different physical or visual locations presents itself under the same interface to the knowledge management layers. Diagrammatically, one can depict the text, the semantic knowledge base, the world (fictional or real), the discourse, the histoire etc. as multiple abstractly related realms, such as illustrated in FIG. 31.

The inherent higher-order capabilities of the hypergraph knowledge representation model allow for direct, natural and unambiguous logical representation of factual knowledge at the appropriate abstraction level. For example, the text remains text even though it is “promoted” as a database entity. The semantic entities referred to within the text (as described above) are detached from it both conceptually and storage-wise. Logical relationships between the semantic entities in the database are stated and exist independently of the text. Logical statements about the structure of the text (such as what constitutes a scene for example in a discourse ontology describing the text itself) pertain directly to the text-as-a-subject-matter. Logical statements about the story itself, the histoire, are also independent from, though related to, both the semantic model of the world and the discourse model of the textual structure. The visual appearance of the creative work as a final product is yet another aspect of representation that must be accounted for and that is yet independent from either text or its semantics—a given paragraph, as a database entity, can be marked as emphasized in one context, but in regular font in another. The design of the different layers and their interconnectedness is built upon the strongly-typed hypergraph formalism.

To illustrate how higher-order relationships come into play, let us expand on the example above. We now have:
A textual sequence of three elements, represented as a triple, a hyperedge with three components:
ID0=[ID1, ID2, ID3]
Each of the graph nodes ID1, ID2, ID3 is plain text.
A semantic temporal entity E1 representing an event in the knowledge base.
A semantic hyperedge of type Mention connecting E1 with ID2 (i.e. a tuple Mention1[E1,ID2]).
A discourse hyperedge of type Sentence consisting of a the singleton tuple [ID0]—this merely serves the purpose of a logical predicate stating that the textual element ID0 is a sentence.

In the context of the hypergraph at large, the elements described above may have further connections:
Event E1 participating in a causal chain of events [E1, . . . , En] or in a temporarily ordered, but causally unrelated event group [E1, . . . , E′m].
Sentence1 as a discourse element could be part of a scene which in turn could be part of a section.
The event E1 can then be inferred by a reasoning system to be mentioned in the given scene, so we have an association between a semantic element of the histoire and structural element of the discours, yet another abstraction layer.

The relational text system may include a database management system with a native knowledge representation model inherently supports querying and reasoning capabilities that can be exposed to the end-user in addition to opening the doors to new forms of delivery and consumption of the creative work, new forms of collaboration between writers and between writers and their fan base. For example, based on the above information, a tool can automatically propose that in fact the event E1 is being described in the section containing the given scene. An intelligent surface reader (see next section) could then be asked to show only the scenes depicting a causal chain of events, a sub-plot of the larger story. Moreover, other type of media elements such as images and videos can naturally be incorporated as database elements and enmeshed with the textual presentation. This sort of intelligence is what the hypergraph knowledge representation paradigm of a text-based creative work affords and that cannot easily be achieved, if at all, with currently existing models.

The management of all these various layers that make up the narrative work and cover different aspects of it are theoretically possible using file-based documents. However, the practical difficulties arising from ad-hoc solutions and the entrenched file-based document paradigm have certainly stifled innovation and adoption of structured knowledge management and AI (Artificial Intelligence) techniques as an integral part of the creative process. Writers are left with fundamentally the same software capabilities for the past three decades. For instance, a recent attempt to embed semantic web (RDF) statement into the Open Document Format (ODF) has failed adoption in large part because the specifications are XML-centric, do not offer the full flexibility that naturally emerges from a native text-as-database model. In fact, the examples in the standards themselves are logically confusing and incorrect—RDF metadata is purported to be about the text whereas in fact, in the examples given, the RDF statement are about the external world. In other words, the picture of the ODF metadata failed attempt is made up of conventional text on one side and an RDF graph on the other side, but the conceptual 3-way relationship between text, knowledge representation and the world described above is absent. So are the higher-order capabilities of the hypergraph knowledge representation that allow one to codify the layered structures of the discours, histoire, the fictional Universe (or real world) fact base etc. In still other instances, the structured metadata described in this Specification may be applied not only to a Narrative Work embodied in text, but also in other media.

As the writing interface of a relational text system allows the user to embed meta-data and logic (like rules and relationships between text elements and metadata elements), certain features become available to a proposed “reading surface” presented by a specialized eBook format particular to the relational text system. Such features may include, for instance highly changeable and adaptable “views” of the same text. For instance, a writer marks scenes in the story as being seen from particular points of view (each point of view being unique to a character). Each scene is marked with a point of view. Then, while reading, a reader is presented with a menu that offers multiple points of view. By choosing any point of view, the reader is able to read the entire story from that character's point of view. Thus the same novel can be read as several intertwined novels. In another example, a writer marks sections of a story or book according to a different reading level. The reader is then able to read the same book with different levels of difficulty (in terms of diction, sentence length, etc.). In yet another example, a writer marks different sections of a book about programming with the levels “newbie,” “advanced,” and “expert.” The reader is then able to read the same book at different levels of familiarity with the domain of programming.

Further, as a relational text system stores text in a highly structured manner in a database, the reader is able to assemble and combine different texts by downloading these different texts and incorporating them into his/her eBook database. In a sense, the reader is able to make his/her own book by downloading and assembling text segments (as permitted by the copyright holder).

The relational text system eBook platform can allow for readers to annotate text with highlighting, comments, etc. The relational text system eBook platform will uniquely allow for collaborative annotating that flows in real time from device to device. We can think of relational text system eBooks as a set of coordinated and linked programs that allow mutual interaction between readers, not limited to annotation—we can allow voice conversations, drawings in real time, etc. Further, a relational text system can have readers collaboratively creating parts of eBooks—the writer can program certain areas of the book to allow for readers to fill in gaps, specify characteristics of elements in the text (the color of the eyes of a character, the breed of a dog, etc.

The eBook generated through a relational text system can be considered a practical implementation of “book as program.” In other words, an eBook may be a data store, which contains data and code. How that code will behave when in interaction with the reader will be determined by the program. The writer of such as an eBook can be thought of as “programming a book.” An interface of the relational text system can be provided that allows a writer to easily deploy a “book programming language” to produce reading-time effects. For instance, the writer programs the reading surface to play a certain media effect (music, video, etc.) when the reader scrolls to a certain position in the document. The writer can program the reading surface to start an animation on demand from the reader. For instance, a text authored by a relational text system may explain the working of the internal combustion engine. By tapping on a sentence of this explanation, the reader is able to see animated movement of pistons. In another example, the writer is able to program text effects, for instance: when the reader reaches a certain designated portion of the text, the text may become bigger and then smaller, change shape and color, vanish and reappear, among other examples. In another example, the relational text system allows a writer to embed cues for augmented reality into the text. For instance, when a reader looks at a page that describes the sea while wearing an augmented-reality kit, the reader may see the sea in the background of the page, hears seagulls overhead, and see a crab out of the corner of his/her eyes, among potentially limitless additional examples.

As noted above, granthas can be used to structure text at a very fine level allowing commands to be attached that can cause certain enhanced presentation effects at “runtime” on specialized reading surfaces on which grantha text is read or interacted with. In one example, a text-scripting language may be provided with a relational text system similar to those languages used to script interactive games (such as the language Lua). A scripting language may be defined as an embedded language that exposes the API of an underlying engine in a higher-level, interpreted manner amenable to manipulation by users who may not necessarily understand the inner workings of this engine. Therefore, a scripting language may be used even by end-users (e.g., the writers using the relational text system to write books or other documents). Such tools may also allow the writer (through the text-scripting language) to encode reading-time effects involving visuals, audio, virtual and augmented reality, and sensations of every sort. For example: the writer may code, “When the reader reaches this section of the document (or a particular portion of the document linked to a particular entity (e.g., a location, setting, character, event, etc.) in his/her reading, make the text gradually blur and disappear.” Or, “If the reader taps on this image three times, make the image become dark and then change into an image of the Mona Lisa.” Or, “If the reader spends more than three seconds on this page, bring up audio of waves on a distant beach,” among other examples. A writer utilizing the relational text system may thereby be able to manipulate various modalities of the text at reading time in response to reader input, whether that input is active (tapping) or passive (time spent on one section of the text extends beyond a certain limit), among other examples.

A text-scripting language may be aware of a multiplicity of possible reading surfaces and allow the writer to create runtime effects that adjust to the capabilities of each specific reading surface. So, a writer could code: “If this text is being read on a phone with a small screen, then increase the text size by 15% when the reader reaches this page; if the text is being read on a tablet-sized screen, increase the text size by 30%.” The scripting language may be able to use all the sensors available on a given reading device (e.g., smartphone, tablet, laptop) as input channels, such as microphones, accelerometers, gyroscopes, compasses, and barometers. Similarly, enhanced presentations based on such scripts may use all the output modalities as well (e.g., visual, sound, etc.). Such a text-scripting language may or may not be Turing-complete and may have all the traditional programming structures common in modern languages (if-then-else structures, loops, functions, etc.) to thereby deploy corresponding enhanced capabilities at the times of composition and reading. Accordingly, a relational text system may allow a writer using the text-scripting language to “program” a book. Within the text editor of the relational text system, a text-scripting language can be represented variously: the writer can attach visual markers (like colored tags) that represent certain effects to be executed at reading-time, the writer can write script-code (similar to writing Lua or Javascript) to achieve more complex and sophisticated effects, among other examples.

According to one embodiment, a multi-media system 200 includes a computer 105, and an interface 120, 115, 265, and 270 connected to the computer. The system 200 also include a module 205 executing on the computer that a user (not shown) enters data into via the interface 120, 115, 265, and 270, the module converts each data entered into a first state and a second state, the first state visible to the user on the interface upon entry by the user, and the second state visible to the user on the interface upon call-up by the user. The system 200 also includes a graph 22 and 24 (FIGS. 19 and 29) generated on the interface 120, 115, 265, and 270 based upon the first state and the second state. The system may additionally include an object 26 (FIG. 26) linked to the data via the graph 22 and 24. The object 26 is not the data, but text, images, sounds, digital files, meta-data, hyperlinks, and the like that the user want associated with the data.

In one embodiment, the system data may include a sequence of TextObjects 28, and the graph 22 and 24 includes edges to which the object 26/TextObject 28 is linked, the object 26/TextObject 28 object includes meta-data. In another embodiment, the graph 22 and 24 includes a hypergraph, a directed graph, and/or a multi-graph, and the graph is not a single tree-like structure.

In one embodiment, the data is imported and/or exported. In another embodiment, the data imported is updated for all users and/or updated as versions. In another embodiment, the data imported is controlled by the user as to version and what data is updated.

In one embodiment, the system 200 also includes a search module 240 that enables a user to examine the data on the system, the first state of the data, the second state of the data, the graph 22 and 24, and/or the object 26/TextObject 28. In another embodiment, the graph 22 and 24 is Visualized on the interface 120, 115, 265, and 270 for the user and the user can observe and manipulate the data in a graphical manner.

In one embodiment, the system 200 further includes an output module 30 in communication with the interface 120, 115, 265, and 270 that generates a product 32 for the user based upon the data. In another embodiment, the data is Tantra formatted so the user experiences the data on the interface 120, 115, 265, and 270 in different configurations.

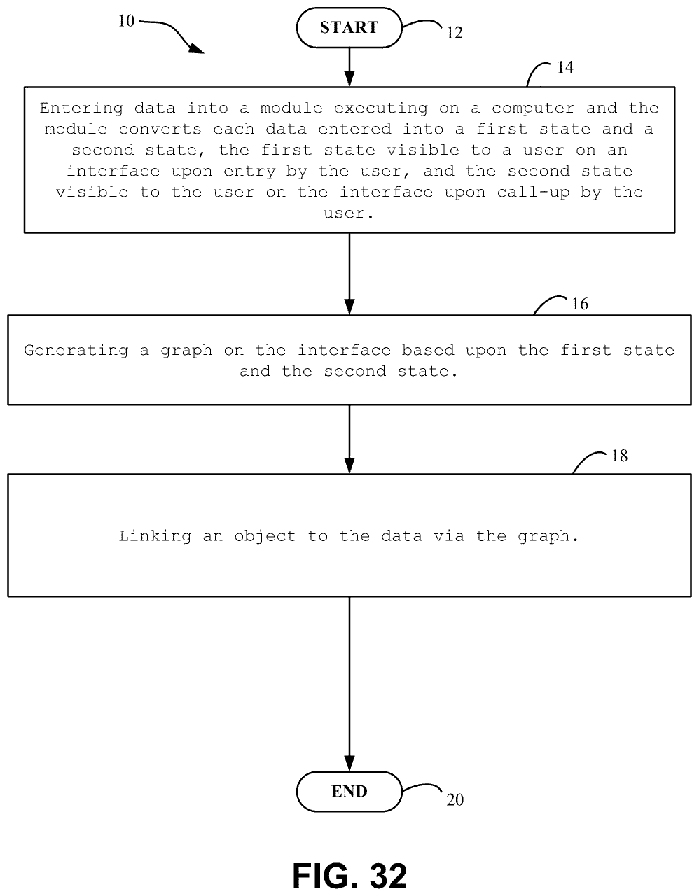

Another aspect of the embodiments is a method, which is now described with reference to flowchart 10 of FIG. 32. The method begins at Block 12 and may include entering data into a module executing on a computer and the module converts each data entered into a first state and a second state, the first state visible to a user on an interface upon entry by the user, and the second state visible to the user on the interface upon call-up by the user at Block 14. The method may also include generating a graph on the interface based upon the first state and the second state at Block 16. The method may further include linking an object to the data via the graph at Block 18. The method ends at Block 20.

The method may additionally include providing a search module that enables a user to examine at least one of the data on the system, the first state of the data, the second state of the data, the graph, and the object. The method may also include Tantra formatting so the user experiences the data on the interface in different configurations.

The method may further include controlling by the user data imported as to version and what data is updated. The method may additionally include outputting a product for the user based upon the data.

Another embodiment is computer readable program codes coupled to tangible media. The computer readable program codes may be configured to cause the program to enter data into a module executing on a computer and the module converts each data entered into a first state and a second state, the first state visible to a user on an interface upon entry by the user, and the second state visible to the user on the interface upon call-up by the user; generate a graph on the interface based upon the first state and the second state; and link an object to the data via the graph.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. In certain implementations, multitasking and parallel processing may be advantageous. Additionally, other user interface layouts and functionality can be supported. Other variations are within the scope of the following claims.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. Systems and tools illustrated can similarly adopt alternate architectures, components, and modules to achieve similar results and functionality. For instance, in certain implementations, multitasking, parallel processing, and cloud-based solutions may be advantageous. Additionally, diverse user interface layouts, structures, architectures, and functionality can be supported. Other variations are within the scope of the following claims.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. A computer storage medium can be a non-transitory medium. Moreover, while a computer storage medium is not a propagated signal per se, a computer storage medium can be a source or destination of computer program instructions encoded in an artificially generated propagated signal. The computer storage medium can also be, or be included in, one or more separate physical components or media (e.g., multiple CDs, disks, or other storage devices), including a distributed software environment or cloud computing environment.

Networks, including core and access networks, including wireless access networks, can include one or more network elements. Network elements can encompass various types of routers, switches, gateways, bridges, load balancers, firewalls, servers, inline service nodes, proxies, processors, modules, or any other suitable device, component, element, or object operable to exchange information in a network environment. A network element may include appropriate processors, memory elements, hardware and/or software to support (or otherwise execute) the activities associated with using a processor for screen management functionalities, as outlined herein. Moreover, the network element may include any suitable components, modules, interfaces, or objects that facilitate the operations thereof. This may be inclusive of appropriate algorithms and communication protocols that allow for the effective exchange of data or information.

The operations described in this specification can be implemented as operations performed by a data processing apparatus on data stored on one or more computer-readable storage devices or received from other sources. The terms “data processing apparatus,” “processor,” “processing device,” and “computing device” can encompass all kinds of apparatus, devices, and machines for processing data, including by way of example a programmable processor, a computer, a system on a chip, or multiple ones, or combinations, of the foregoing. The apparatus can include general or special purpose logic circuitry, e.g., a central processing unit (CPU), a blade, an application specific integrated circuit (ASIC), or a field-programmable gate array (FPGA), among other suitable options. While some processors and computing devices have been described and/or illustrated as a single processor, multiple processors may be used according to the particular needs of the associated server. References to a single processor are meant to include multiple processors where applicable. Generally, the processor executes instructions and manipulates data to perform certain operations. An apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, module, (software) tools, (software) engines, or code) can be written in any form of programming language, including compiled or interpreted languages, declarative or procedural languages, and it can be deployed in any form, including as a standalone program or as a module, component, subroutine, object, or other unit suitable for use in a computing environment. For instance, a computer program may include computer-readable instructions, firmware, wired or programmed hardware, or any combination thereof on a tangible medium operable when executed to perform at least the processes and operations described herein. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Programs can be implemented as individual modules that implement the various features and functionality through various objects, methods, or other processes, or may instead include a number of sub-modules, third party services, components, libraries, and such, as appropriate. Conversely, the features and functionality of various components can be combined into single components as appropriate. In certain cases, programs and software systems may be implemented as a composite hosted application. For example, portions of the composite application may be implemented as Enterprise Java Beans (EJBs) or design-time components may have the ability to generate run-time implementations into different platforms, such as J2EE (Java 2 Platform, Enterprise Edition), ABAP (Advanced Business Application Programming) objects, or Microsoft's .NET, among others. Additionally, applications may represent web-based applications accessed and executed via a network (e.g., through the Internet). Further, one or more processes associated with a particular hosted application or service may be stored, referenced, or executed remotely. For example, a portion of a particular hosted application or service may be a web service associated with the application that is remotely called, while another portion of the hosted application may be an interface object or agent bundled for processing at a remote client. Moreover, any or all of the hosted applications and software service may be a child or sub-module of another software module or enterprise application (not illustrated) without departing from the scope of this disclosure. Still further, portions of a hosted application can be executed by a user working directly at a server hosting the application, as well as remotely at a client.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), tablet computer, a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device, including remote devices, which are used by the user.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include any internal or external network, networks, sub-network, or combination thereof operable to facilitate communications between various computing components in a system. A network may communicate, for example, Internet Protocol (IP) packets, Frame Relay frames, Asynchronous Transfer Mode (ATM) cells, voice, video, data, and other suitable information between network addresses. The network may also include one or more local area networks (LANs), radio access networks (RANs), metropolitan area networks (MANs), wide area networks (WANs), all or a portion of the Internet, peer-to-peer networks (e.g., ad hoc peer-to-peer networks), and/or any other communication system or systems at one or more locations.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

As will be appreciated by one skilled in the art, aspects may be embodied as a system, method, and/or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the embodiments are described above with reference to flowchart illustrations and/or block diagrams of methods, apparatus (systems) and computer program products according to the embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiment was chosen and described in order to best explain the principles of the embodiments and the practical application, and to enable others of ordinary skill in the art to understand the various embodiments with various modifications as are suited to the particular use contemplated.

While the preferred embodiment has been described, it will be understood that those skilled in the art, both now and in the future, may make various improvements and enhancements which fall within the scope of the claims which follow. These claims should be construed to maintain the proper protection for the embodiments first described.

What is claimed is:

1. A system comprising:
a computer;
an interface connected to the computer;
a module executing on the computer that a user enters data into via the interface, the module converts each data entered into a first state and a second state, the first state visible to the user on the interface upon entry by the user, and the second state visible to the user on the interface upon call-up by the user;
a graph generated on the interface based upon the first state and the second state; and
an object linked to the data via the graph.

2. The system of claim 1 wherein the data comprises a sequence of TextObjects, and wherein the graph includes edges to which the object is linked, and wherein the object comprises meta-data.

3. The system of claim 1 wherein the graph includes at least one of a hypergraph, a directed graph, and a multi-graph, and wherein the graph is not a single tree-like structure.

4. The system of claim 1 wherein the data can be imported and exported.

5. The system of claim 4 wherein the data imported is at least one of updated for all users, and updated as versions.

6. The system of claim 4 wherein the data imported is controlled by the user as to version and what data is updated.

7. The system of claim 1 further comprising a search module that enables a user to examine at least one of the data on the system, the first state of the data, the second state of the data, the graph, and the object.

8. The system of claim 1 wherein the graph is Visualized on the interface for the user and the user can observe and manipulate the data in a graphical manner.

9. The system of claim further comprising an output module in communication with the interface that generates a product for the user based upon the data.

10. The system of claim 1 wherein the data comprises Tantra formatting so the user experiences the data on the interface in different configurations.

11. A method comprising:
entering data into a module executing on a computer and the module converts each data entered into a first state and a second state, the first state visible to a user on an interface upon entry by the user, and the second state visible to the user on the interface upon call-up by the user;
generating a graph on the interface based upon the first state and the second state; and
linking an object to the data via the graph.

12. The method of claim 11 further comprising providing a search module that enables a user to examine at least one of the data on the system, the first state of the data, the second state of the data, the graph, and the object.

13. The method of claim 11 further comprising Tantra formatting so the user experiences the data on the interface in different configurations.

14. The method of claim 11 further comprising controlling by the user data imported as to version and what data is updated.

15. The method of claim 11 further comprising outputting a product for the user based upon the data.

16. A computer program product embodied in a tangible non-transitory media comprising:
computer readable program codes coupled to the tangible non-transitory media to provide a canalphone specification, the computer readable program codes configured to cause the program to:
enter data into a module executing on a computer and the module converts each data entered into a first state and a second state, the first state visible to a user on an interface upon entry by the user, and the second state visible to the user on the interface upon call-up by the user;
generate a graph on the interface based upon the first state and the second state; and
link an object to the data via the graph.

17. The computer program product of claim 16 further comprising program code configured to: provide a search module that enables a user to examine at least one of the data on the system, the first state of the data, the second state of the data, the graph, and the object.

18. The computer program product of claim 16 further comprising program code configured to: Tantra format so the user experiences the data on the interface in different configurations.

19. The computer program product of claim 16 further comprising program code configured to: control by the user data imported as to version and what data is updated.

20. The computer program product of claim 16 further comprising program code configured to: output a product for the user based upon the data.
